(19) United States
(12) Patent Application Publication
(10) Pub. No.: US 2006/0224975 A1
(43) Pub. Date: Oct. 5, 2006

(54) System for creating a graphical application interface with a browser

(76) Inventors: Paul Albrecht, Bedford, MA (US); Paul Grimshaw, Acton, MA (US); Joseph G. Hadzima JR., Wellesley, MA (US); Hoo-Min D. Toong, Cambridge, MA (US); Kimberly Chiu, Quincy, MA (US); Vicent Chiu, Quincy, MA (US); Lillian Dai, Cambridge, MA (US); Fenghua Lu, Woburn, MA (US); Xiao Ping Yang, Boston, MA (US); Tiejun Zhang, Boylston, MA (US)

Correspondence Address: BERKELEY LAW & TECHNOLOGY GROUP, 1700NW 167TH PLACE, SUITE 240, BEAVERTON, OR, 97006, US

(21) Appl. No.: 11/096,564

(22) Filed: Apr. 1, 2005

(51) Int. Cl. G06F 17/00

(52) U.S. Cl. 715/760

(57) ABSTRACT

Embodiments of a system for creating a graphical application interface with a browser, such as a web browser, are disclosed.

### RELATED APPLICATIONS

The following concurrently filed patent applications are commonly assigned, related to this patent application, and herein incorporated by reference: “APPARATUS FOR CREATING GRAPHICAL APPLICATION INTERFACE,” by Albrecht at al., attorney docket number 023.P004, U.S. patent application Ser. No. ______; “METHOD OF USING A BROWSER,” by Albrecht et al., attorney docket number 023.P001, U.S. patent application Ser. No. ______; “SYSTEM FOR CREATING A GRAPHICAL APPLICATION INTERFACE,” by Albrecht et al., attorney docket number 023.P006, U.S. patent application Ser. No. ______; “GRAPHICAL APPLICATION INTERFACE PRODUCT,” by Albrecht et al., attorney docket number 023.P007, U.S. patent application Ser. No. ______; “GRAPHICAL APPLICATION INTERFACE,” by Albrecht et al., attorney docket 023.P005, U.S. patent application Ser. No. ______; “METHOD OF CREATING GRAPHICAL APPLICATION INTERFACE WITH A BROWSER,” by Albrecht et al., attorney docket 023.P002, U.S. patent application Ser. No. ______; “APPARATUS FOR CREATING GRAPHICAL APPLICATION INTERFACE WITH A BROWSER,” by Albrecht at al., attorney docket number 023.P008, U.S. patent application Ser. No. ______; “METHOD OF CREATING GRAPHICAL VISUALIZATIONS OF DATA WITH A BROWSER,” by Albrecht et al., attorney docket number 023.P003, U.S. patent application Ser. No. ______; “GRAPHICAL APPLICATION INTERFACE USING BROWSER,” by Albrecht et al., attorney docket number 023.P009, U.S. patent application Ser. No. ______; “GRAPHICAL APPLICATION INTERFACE PRODUCT USING A BROWSER,” by Albrecht et al., attorney docket number 023.P011, U.S. patent application Ser. No. ______; APPARATUS FOR CREATING GRAPHICAL VISUALIZATION OF DATA WITH A BROWSER,” by Albrecht at al., attorney docket number 023.P012, U.S. patent application Ser. No. ______; “GRAPHICAL VISUALIZATION OF DATA USING BROWSER,” by Albrecht et al., attorney docket number 023.P013, U.S. patent application Ser. No. ______; “SYSTEM FOR CREATING A GRAPHICAL VISUALIZATION OF DATA WITH A BROWSER,” by Albrecht et al., attorney docket number 023.P014, U.S. patent application Ser. No. ______; and “GRAPHICAL VISUALIZATION OF DATA PRODUCT USING A BROWSER,” by Albrecht et al., attorney docket number 023.P015, U.S. patent application Ser. No. ______.

### BACKGROUND

Software for browsing, such as for browsing stored data and/or for web-browsing is well-known. Although at times convenient, this approach to presenting data has some disadvantages. For example, it may be difficult to provide end-users with features of an interface typically associated with a software application, such as, for example, pull down menus and/or other features, referred to here as graphical application-like interface features. A reason for this at least in part is the use of HTML to layout text, images and/or other data on a page, such as a web page. HTML is not a convenient mechanism for this.

One approach to address this issue is the use of browser or web-browser “plug-ins.” Here, this refers to software that operates in conjunction with the web-browser software to provide a desired graphical application-like interface to the end user. However, employing such software raises other issues, such as security concerns and work-flow issues in connection with use of the browser.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIGS. 1 to 50 are schematic diagrams illustrating various views of capabilities of an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

As previously indicated, browser interfaces have become ubiquitous. However, employing browser interfaces in some computing environments may impose limitations as well. In particular, browsers use HTML and HTML-based graphics makes producing real-time and/or interactive visualizations a challenge. In the discussion of an embodiment that follows, innovative patent visualizations, analysis, and/or intellectual property strategy tools are discussed. However, it should be clear that claimed subject matter is not limited in scope to patent-related visualizations and data. Any potential application, such as a web application, for example, is intended to be included within the scope of claimed subject matter. Features of this particular embodiment, however, without loss of generality, include:
interactive patent maps that provide quick visualization of complex relationships between patents and/or patent applications,
an advanced patent search method through patent reference citations,
a seamless interface between map and list visualizations,
statistical analysis tools for groups of patents and/or applications,
business and intellectual property strategy planning tools, and/or
a method to re-perform a previous sequence of analysis effortlessly.

Although a standard browser is familiar to most computing platform users, it has been difficult historically to give a user a graphical application-like experience via a browser, such as a web browser. In this context, the term graphical application-like features or graphical application-like visualizations refers features that permit a standard browser to behave like a graphical software application and/or to create graphical visualizations. In particular, through a variety of techniques, described in more detail hereinafter, embodiments of claimed subject matter permit a standard browser to exhibit many graphical application-like features and/or to create graphical application-like visualizations of data.

Map View

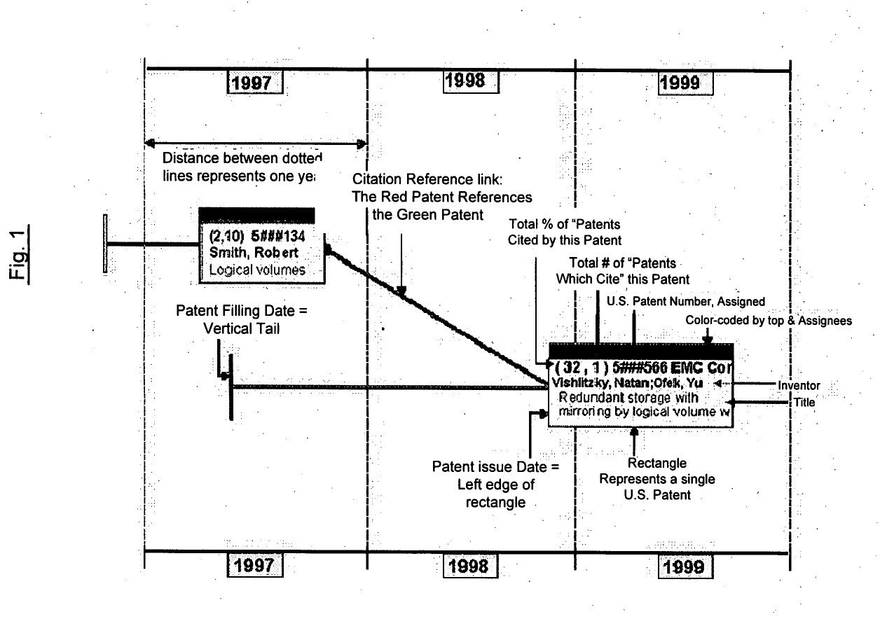

A feature of one particular embodiment, in this context, includes a graphic referred to here as a map. Here, a map provides a graphic which presents patents visually in time context as illustrated in FIG. 1. In this particular embodiment, information displayed on the map, may include:

a timeline along the x-axis with an appropriate year range selected to cover filing dates and/or issuing dates of patents and/or patent applications depicted by the particular map. For a larger map, a time axis label may be repeated several times on the map; Patent boxes containing key information about depicted patents and/or patent applications, such as: number of forward and/or backward citations, patent number and/or patent application number, assignee name, inventor name(s), and patent or patent application title; strips at the top of patent boxes color coding user selected categories, such as assignees, for example; shadings along the sides of patent boxes to differentiate patent applications from issued patents; color coding of patent boxes by user selected criteria; patent filing date—indicated by a bar extending to the filing date; patent issued date—indicated in time by the left side of a patent box; and/or citation links between patent boxes.

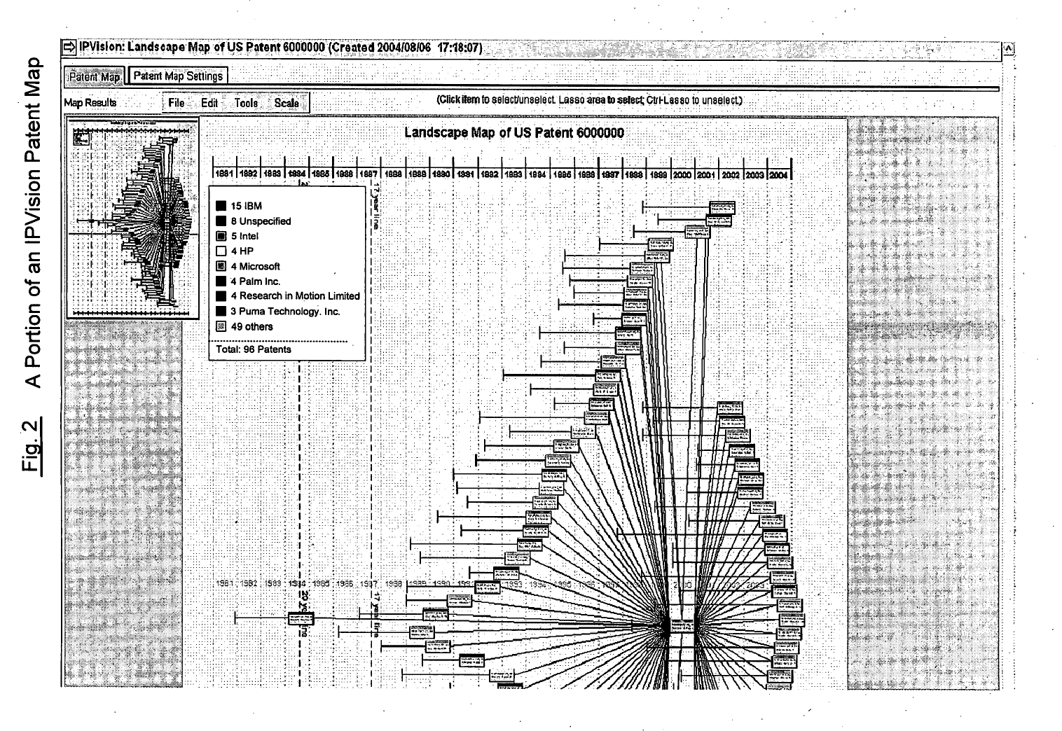

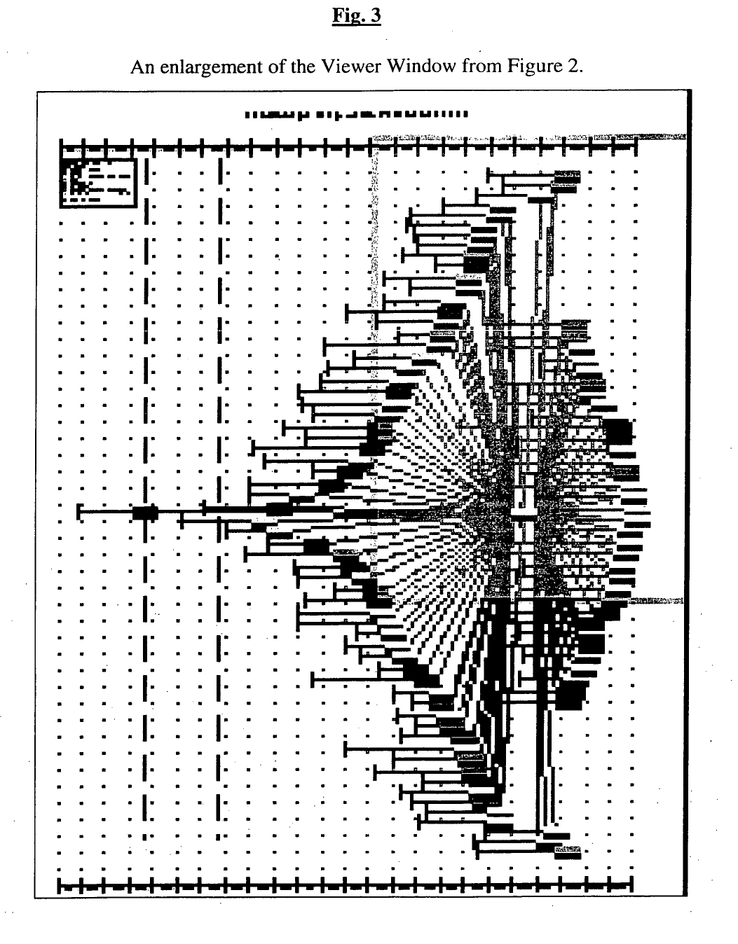

As shown in FIG. 2, additional items on the map may include: a map title; a 17 year line and a 20 year line dividing expired and non-expired patents; one or more legends that provide various statistics of the patents and/or applications on the map, including the number of patents per specified category and the total number of patents and/or applications depicted in view; type of statistical data specified by the user; and a smaller viewer window for map navigation.

In this particular embodiment, a visualization map may provide a powerful and/or useful tool that combines unique features for patent and/or application relationship visualization and/or analysis. Below, features of this particular embodiment of a visualization map are discussed. However, as previously indicated, while examples are discussed in terms of patent and/or application related data, claimed subject matter is not limited in scope in this respect. Furthermore, in this context, the term patent is intended to include patent applications as well, regardless of whether or not patent applications are specifically mentioned or referenced in any particular discussion hereinafter. Likewise, it is noted that subject headings and/or other transitions between materials herein are provided simply for convenience and do not limited claimed subject matter in anyway.

Interconnection and Landscape Maps

This particular embodiment illustrates two types of maps: interconnection maps and/or landscape maps. In this particular context, an interconnection map shows citation reference relationships among a set of patents and/or patent applications. Given a set of patents and/or applications, in this embodiment, a link between two patents and/or applications is shown on a map if one is cited by another. For a group of reference patents and/or applications, therefore, one may compare interconnection densities. In this particular embodiment, patent clusters that are more densely connected are displayed towards the top of a map, providing fast assessment of the relative strength of such patent associations, although claimed subject matter is not limited in scope in this respect.

Landscape maps, here, show patent citations referenced around a patent or a set of patents. Given a set of reference patents, for example, patents that cite any of the reference patents (e.g., forward citations) and patents that are cited by any of the reference patents (e.g., backward citations) are displayed on the map, along with the original set of reference patents. A link exists between a patent and a reference patent if one is cited by another. Note that some patents that cite the reference patents may also cite one another. These citation relationships are shown on an interconnection map, but are not shown on a landscape map. Some reference patents may also cite one another. These relationships are shown on a landscape map. For a particular patent, the number of citations shown on a landscape map may give an indication of the “strength” of the patent. A patent that has several forward citations may indicate that the patent describes valuable technology. A patent that references several patents may indicate that it is a relatively minor improvement or may indicate that the patent bridges several technology fields. Furthermore, a patent that has several forward citations that have issued recently may indicate an up and coming technology field stemming from the patent.

Viewer Window

Patent maps may be quite large. It may, therefore, be difficult to navigate around a large map, even using a browser. In this particular embodiment, this may be addressed using a viewer window, here, a smaller representation of a larger map. A viewer window may be seen, for example in the upper left corner of the browser window in FIG. 2. FIG. 3 is an enlargement of the viewer window shown in FIG. 2.

In this particular example, an area in the viewer window shows the portion of the map which is visible in the full window, although claimed subject matter is not limited in scope in this respect. Using a mouse or other input device, a user may “grab” and move the yellow area around the viewer window to expose different areas of the full window. Alternatively, the main map may be moved by an Aft—cursor drag combination, for example, in another embodiment. The area in the viewer window may then move correspondingly. Likewise, for this particular embodiment, the dimensions of area change as the area is dragged in the viewer window.

Hover/Enlargement

Although a viewer window may make it more convenient to explore contents of a map, objects may be small if the number of objects is large. However, in one embodiment, a Hover/Enlargement capability in the browser may allow a user to view an object as “magnified”. FIG. 5, for example, shows Hover/Enlargement of U.S. Pat. No. 6,000,000 from a map shown in FIG. 2. In this particular embodiment, a magnified box displays information about an object a cursor crosses over via a window. As a user moves the cursor, a different box may be magnified in turn. Here, this Hover/Enlargement feature of this particular embodiment, together with a citation count shown may allow a user to review large amounts of data relatively quickly.

Access to Data and Further Analysis

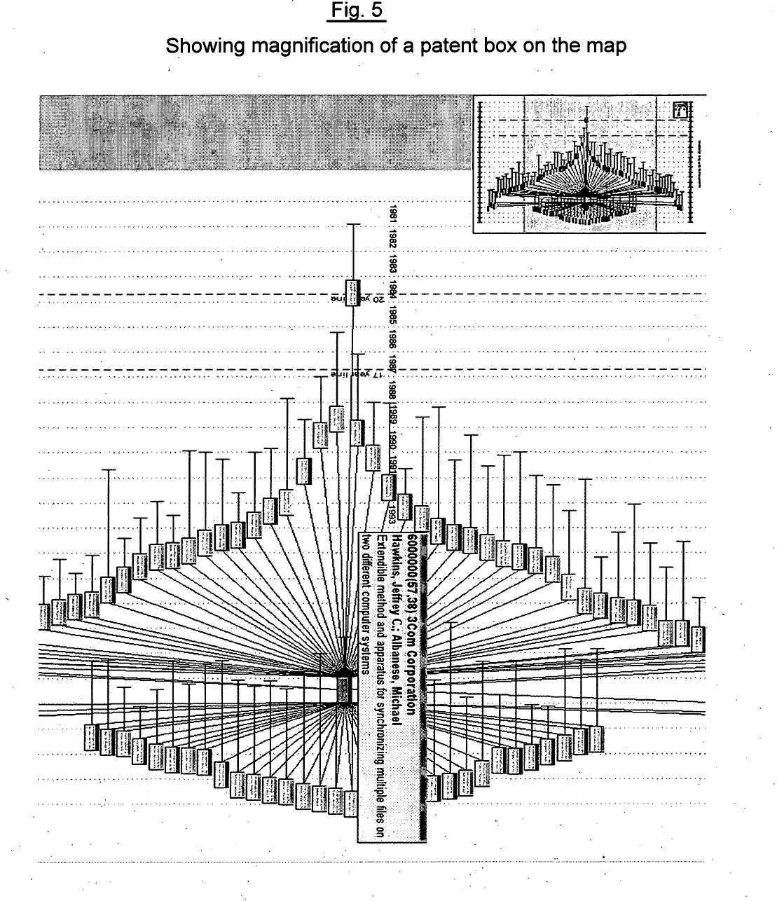

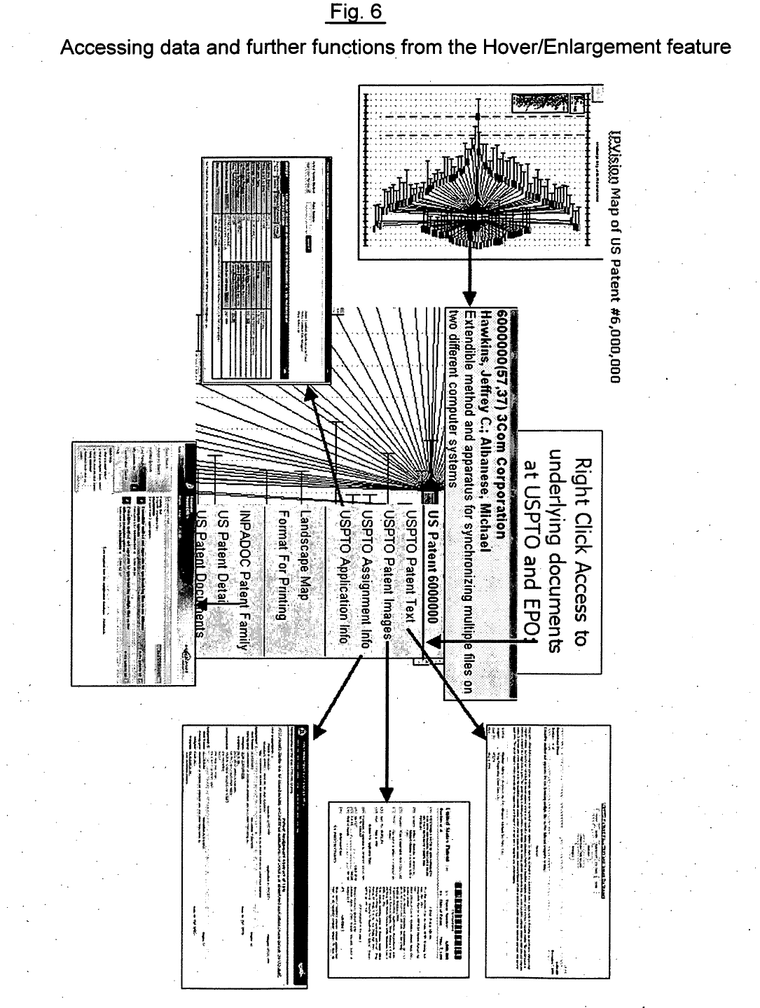

For example, from a magnified patent box in this embodiment, for example, a user may “right click” to access a variety of data and further actions relating to a magnified object. FIG. 6 illustrates examples of data sources relating to an object which may be accessed from a visual representation of the object. In this case, the object is U.S. Pat. No. 6,000,000 and the data sources comprise: the full text of the patent from the US Patent and Trademark Office in html and PDF formats; the image file of the patent as issued; the USPTO Assignment information database entry for the patent; the USPTO Prosecution History database entry for the patent; and the European Patent Office databases containing the INPADOC patent family data for the patent.

Further analyses may also be initiated from the object. In FIG. 6, there is a menu item for a landscape map of the patent, for example. Selecting this option generates a patent map based at least in part on the object. In FIG. 7, for example, U.S. Pat. No. 6,324,544 cites U.S. Pat. No. 6,000,000. Here, “right clicking,” for example, on the magnified box for U.S. Pat. No. 6,324,544 generates a landscape map for U.S. Pat. No. 6,324,544 in this particular embodiment. Likewise, right clicking in this particular embodiment generates detailed patent information, including citation references. These may be viewed in a table format, which can be formatted for printing in this particular embodiment. Of course, claimed subject matter is not limited in scope to these particular embodiment details. These are merely examples for the purpose of illustration.

Interactivity on a Map

In this particular embodiment, a user may select objects for further review and/or analysis using a variety of selection and de-selection techniques. These may include, for example: selection and de-selection of single objects by clicking on an object; selection of multiple single objects by shift or aft or control or other keystrokes while clicking on objects; de-selection of selected single objects by a similar method; selection of clusters or groups of objects by lassoing or dragging with a mouse pointer to highlight objects; and/or de-selection of cluster or groups of selected objects by ctrl-lassoing. While these may comprise common methods for selection in computer software applications, these are not common in standard browsers without plug-ins.

In this particular embodiment, a toolbar feature may likewise permit convenient exporting data in particular formats, although claimed subject matter is not limited in scope in this respect. Again, there are merely illustrative examples. However, these features may include:

File—Save a map to disk or export map to other file formats including Visio, pdf, and/or emf.

Edit—Select by category (categories may include, for example, primary assignees, assignees, primary inventors, inventors, primary main classes, etc.), select by list, select by patent ID, select all (select all of the patents on a map), unselect all (unselect all of the patents on a map), create sublist from selected, and/or create sublist from unselected.

Scale—Scaling a map by 2%, 5%, 10%, 25%, 50%, 75%, 100%, 150%, and/or 200%. In one embodiment, a range of scaling may be automatically determined based at least in part on the amount of information to be displayed.

Selection by Category

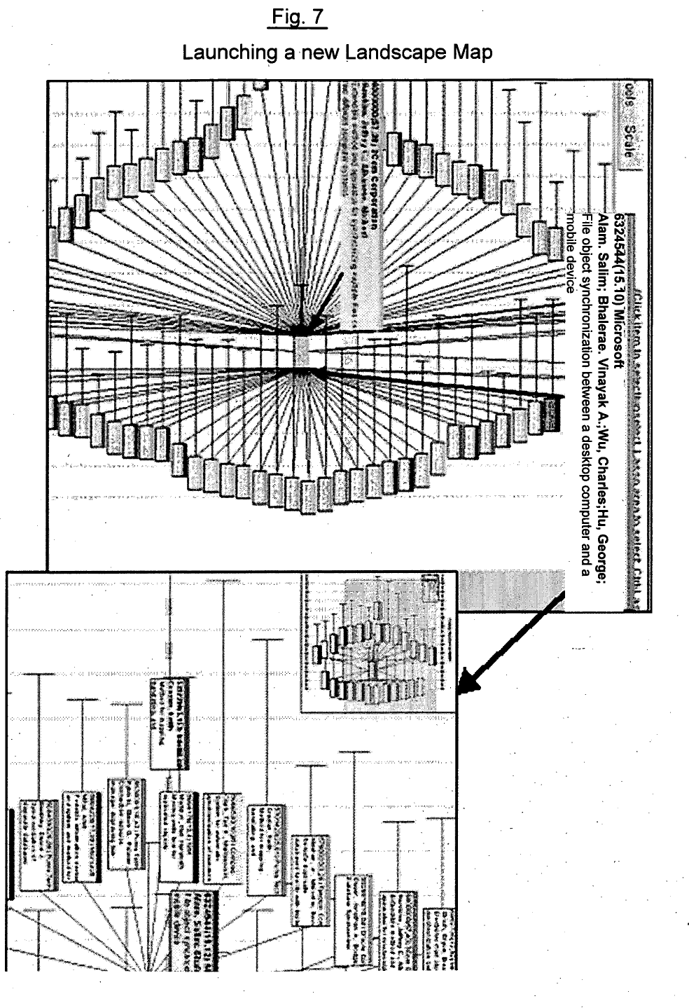

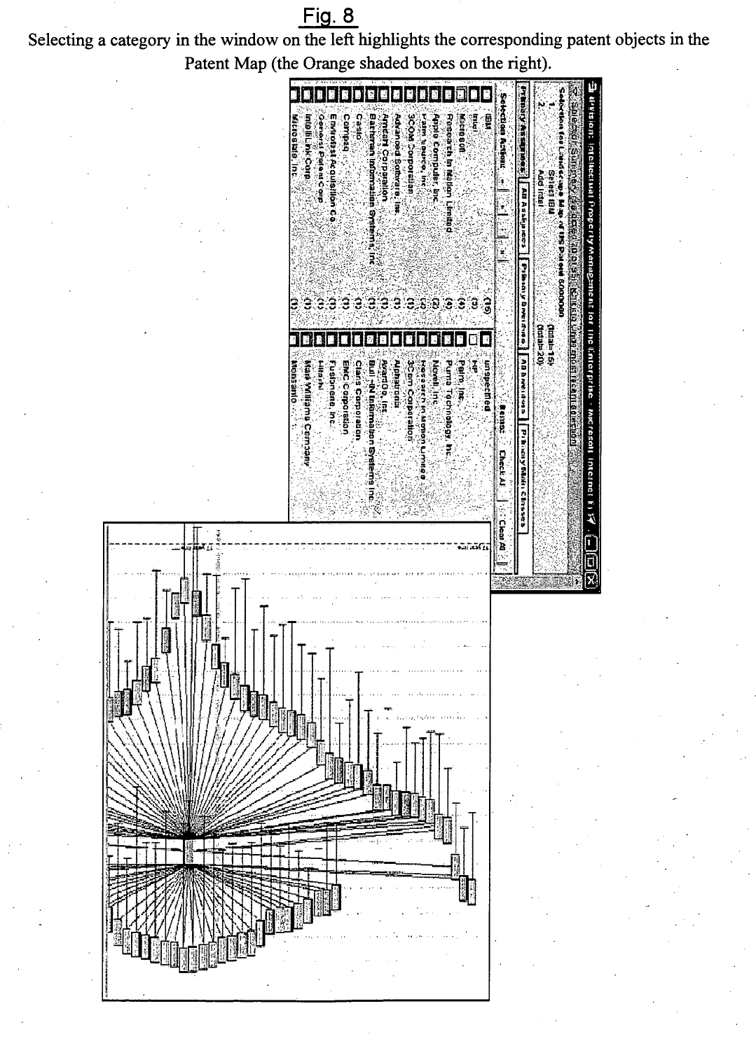

A useful method for selecting objects is by common categories. A Selection by Category window may allow patents to be selected by a combination of primary assignees, all assignees, primary inventors, all inventors, and/or primary main US patent classes, for example, in this particular embodiment. In FIG. 8, for example, IBM and Intel are selected in a Selection by Category window and corresponding patent objects are highlighted on a corresponding map. In a Selection by Category window, the number of patents that are associated with a particular assignee, inventor, or patent class is shown. The lists are sorted such that assignees, inventors, or patent classes that have the most number of associated patents are displayed towards the top of the lists for this particular embodiment.

A user may select and deselect items in the Selection by Category window individually or by the “check all” and/or “clear all” buttons. Selected assignees, inventors, and/or patent classes may be added or removed incrementally by a set of Selection Action Operators, such as, for this embodiment, arithmetic symbols “=”, “+”, “−”, and “×”, as explained below. Of course, claimed subject matter is not limited in scope to these particular symbols. The sequence of actions performed is summarized in a Selection Summary list, which may be expanded or reduced to reveal or hide a sequence respectively.
“=” removes all previous action sequences from a Selection Summary list and adds the currently selected set of patents
“+” adds currently selected patents
“−” removes currently selected patents
“×” adds patents that are common to a set of currently selected patents

These operators are used in Selection by List and ID as well. Selection Summary list in this particular embodiment allows a user to select patents based at least in part on a combination of selection by category, list, and/or ID. This list may be expanded or hidden from view in this particular embodiment. A graphical application-like feature, “Click to undo most recent selection” allows a user to undo prior selections and/or de-selections in this particular embodiment.

If selected objects are highlighted in a map view, one may readily visualize citation relationships among selected patents in this particular embodiment.

Selection by List

Patent selection may also come from lists which are not directly connected to a map in this particular embodiment. For example, as illustrated in FIG. 9, a user may have a list comprising a portfolio of patents while exploring a map of a patent not in the portfolio. The user may therefore in this embodiment invoke the Select by List function and may select the particular portfolio list to see if any of the patents in the portfolio appear on the map being reviewing, for example. The Selection Action Operators may be applied here to allow selection of multiple lists.

Selection by Patent ID

Patents in the map may also be selected by ID, such as where a user may enter a patent number, inventor name, company name, etc, on a freeform basis and any of the objects on the map matching that ID may be highlighted as a result in this particular embodiment. An example of selection by patent number is shown in FIG. 10. Multiple patents may be selected by entering the IDs of different patents.

Create Sublist from Selected or Unselected

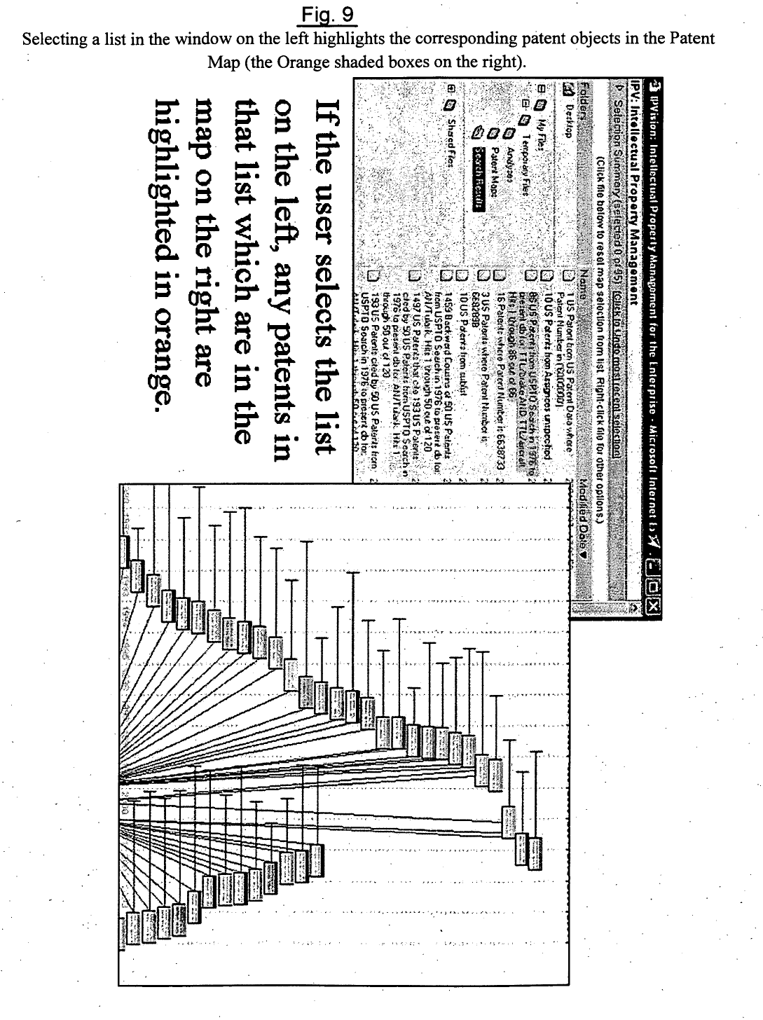

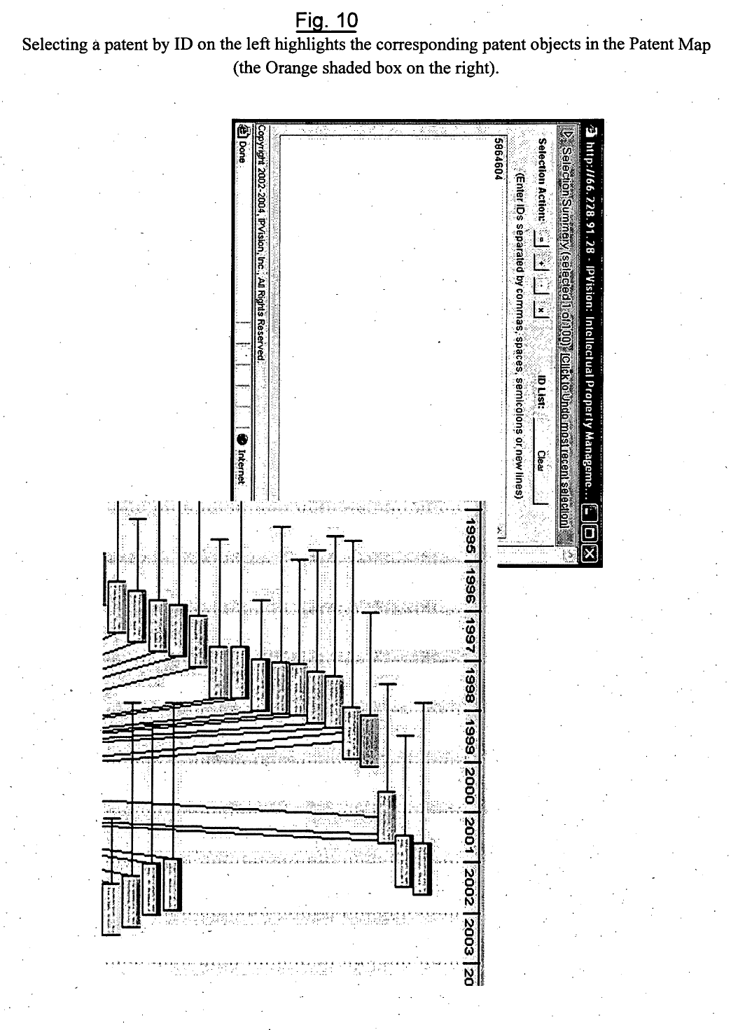

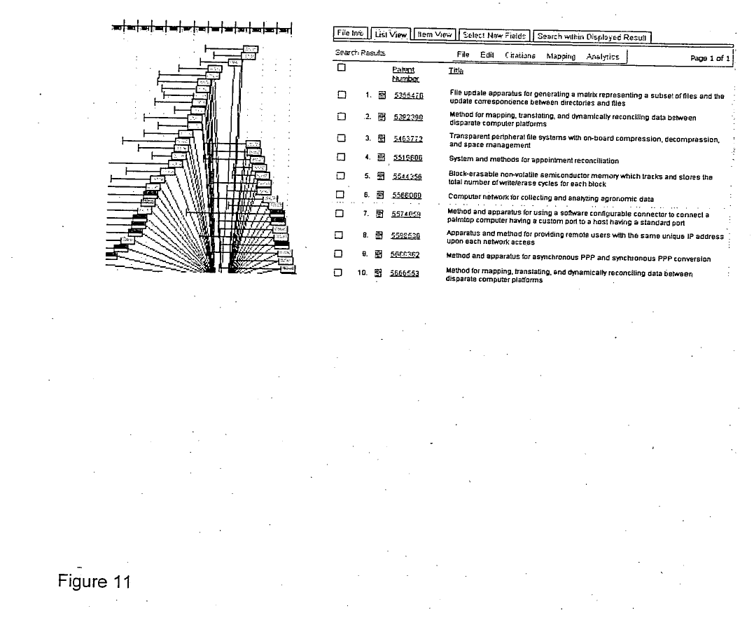

A group of patents may be selected in map view or by using other selection methods, such as those discussed above. The selected or unselected patents may, for example form a sublist for further analysis. FIG. 11 shows a sublist of selected patents from a map, for example.

Patent Map Settings

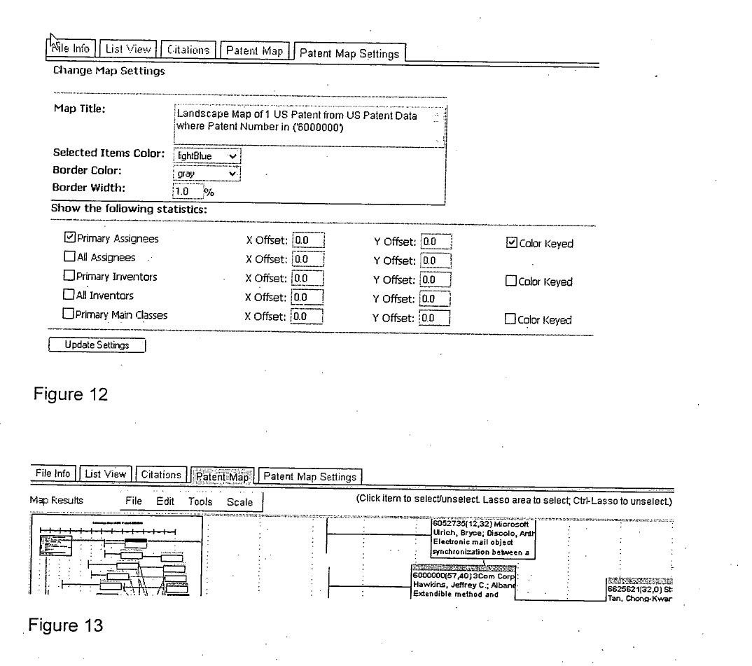

Various features in a map view may be customized in this particular embodiment. Customization options are shown, for example, in FIG. 12. A user may for example change the title of the map, the color or the selected patent boxes, and/or map view border color and/or width. Providing different colors for patent boxes according to user specified categories may be useful at times for visual analysis.

Statistical information may also be displayed in the legend area on a map. Statistical information in this particular embodiment may include assignees, inventors, and/or patent classes, for example. Location of legend boxes may be specified by X and Y Offset coordinates. A user may also choose to color code the strip at the top of patent boxes based at least in part on assignee, inventor, and/or patent classes, for example.

List View

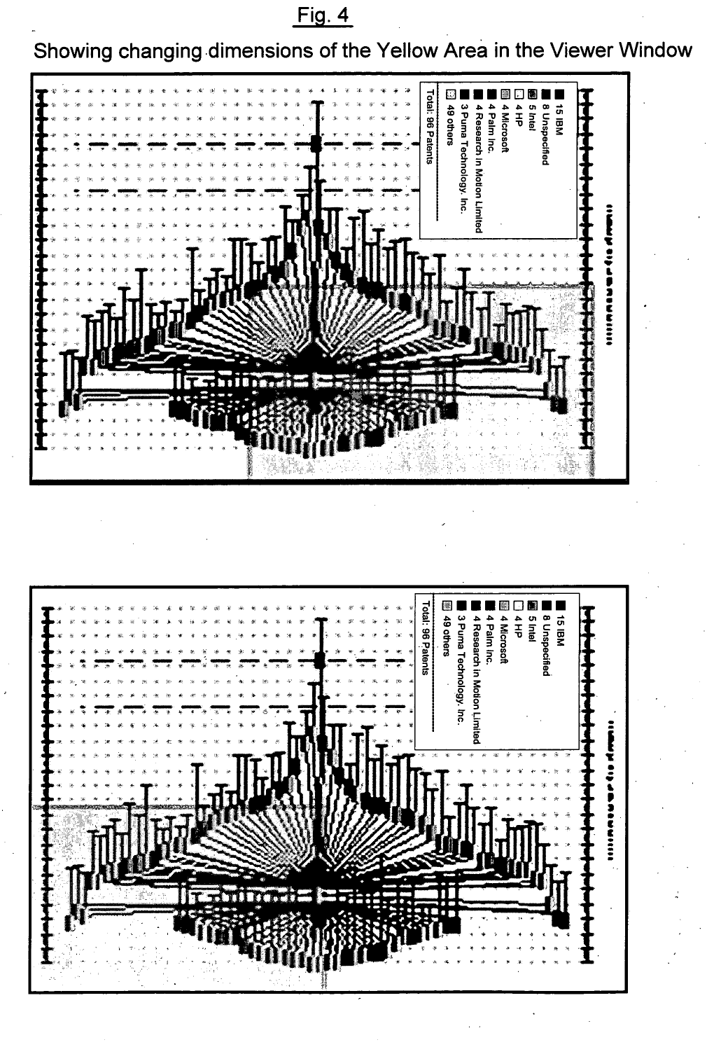

The ability to select and review patents may be enhanced if a user is presented with a variety of ways to access and/or view data. A graphic, such as a map, may therefore provide visual representation, such shown in FIGS. 1-12 above. Likewise, here, underlying data may be presented in list format. FIG. 13, for example, shows the top part of a patent map view. In this particular embodiment, there are a number of “tabs” at the top, including one labeled “List View”.

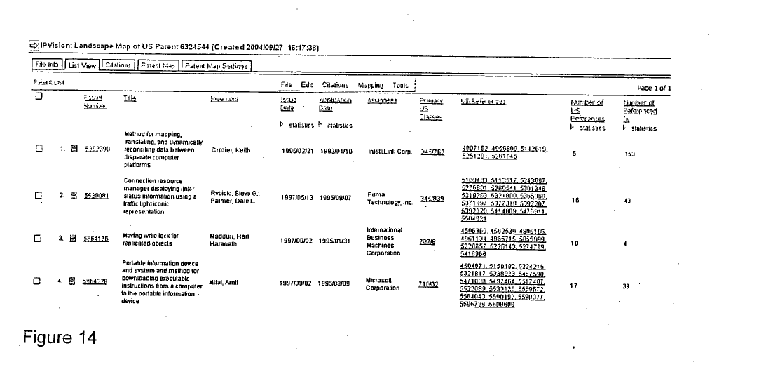

In list view, for example, underlying data corresponding to the objects in the graphic may be presented, as illustrated, for example, in FIG. 14. A row in the list may present data about an object on the map, in this case patents, for example. Thus, as suggested, in this embodiment, a list view may be tightly coupled with a map view.

Title Row

A Title Row may in this particular embodiment include: a box that allows a user to select all of the patents in the list, Patent Number, Title, Inventors, Issue Date, Application Date, Assignees, Primary US Classes, US References, Number of US References (e.g., Backward citations), and/or Number of Referenced By (e.g., Forward citations). In the Issue Date and Application Date fields, a drop-down Statistics button may display the min, max, and median issue and application dates respectively for patents in the list. The median age of the patents may also be displayed. In the Number of US References and Number of Referenced By fields, a Statistics button may display the min, max, median, and mean numbers of backward and forward citations respectively per patent.

List Sort

A column may be sorted in ascending or descending order by clicking on a column title. Clicking on a title once sorts the list in ascending order. Clicking it again sorts in descending order.

Access to Data for Further Analysis

Clicking on a patent number in this embodiment may provide additional data about the patent. In a row, a document icon may provide a list of functions upon left or right clicking on the icon. These functions correspond to the “right click action” in map view in this particular embodiment.

Patent Selection and Display

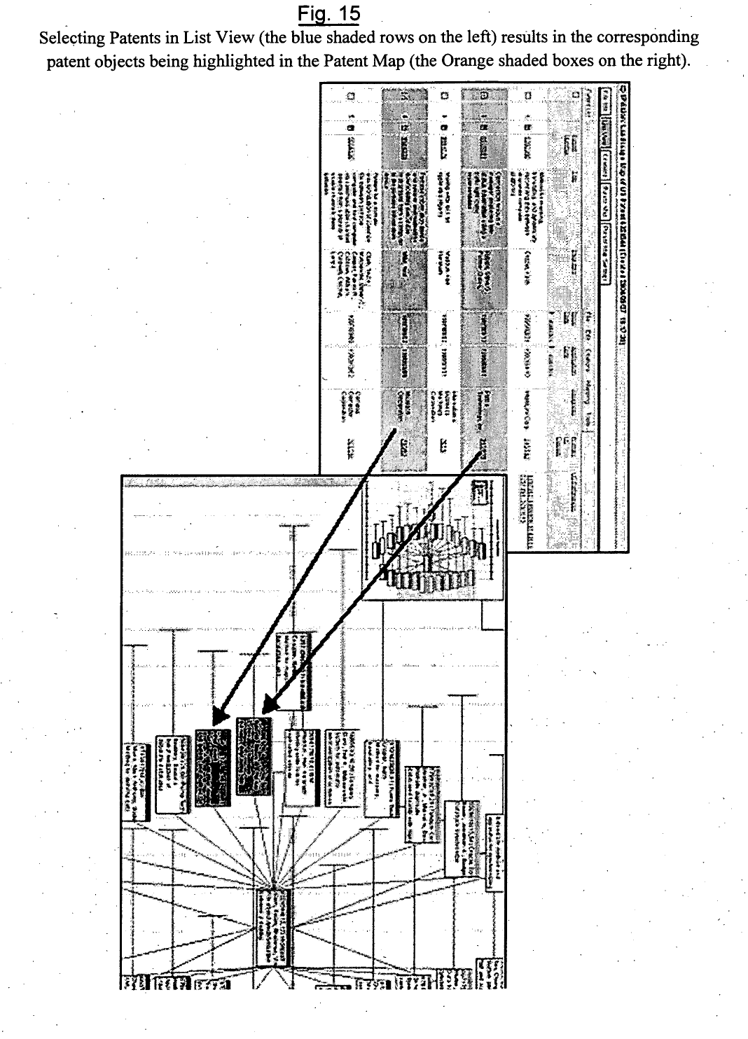

A user reviewing patent data in list view may find it helpful to select patents in the list view and see their corresponding placement in a map view, such as illustrated in FIG. 15, for example. Selected patents in list view may also be highlighted across a row containing the patent. These patents may also be highlighted in map view. Conversely, highlighted patents on a map may be highlighted in list view. De-selecting selected patents in either list view or map view may therefore deselect the patent in both views in this particular embodiment.

A list toolbar may also allow further actions to be performed. These may include:

File—Save File, Save as Report Maker, Save List as Portfolio, Add Note, Export as CSV, and/or Export as Excel, for example

Edit—Create Sublist from Selected, Create Sublist from Unselected, and/or Show US References from Selected, for example

Citations—Forward citation list, Forward cousin list, Backward citation list, Backward cousin list, and/or Citation analysis, for example

Mapping—Interconnection map, Landscape map, Forward Landscape Level 1 and 2, Backward Landscape 1 and 2, Key prior art, Licensing opportunity, Forward citation cross dependencies, and/or Backward citation cross dependencies, for example

Analytics—Agent Analysis, Assignee Analysis, Examiner Analysis, Inventor Analysis, Filing Date Analysis, Issue Date Analysis, US Class Analysis, US Class Pair Analysis, and/or Find Similar Patents, for example

Special—Shape Drop Map, and/or Shape Drop Map By Class, for example.

Save File

A list may be saved as File, Report Maker, or Portfolio. The Save File option allows a list to be saved in a user defined folder, along with a description of the list and additional Notes. The Save as Report Maker option allows a user to specify a fixed set of fields such that those fields may be displayed if the file is reopened.

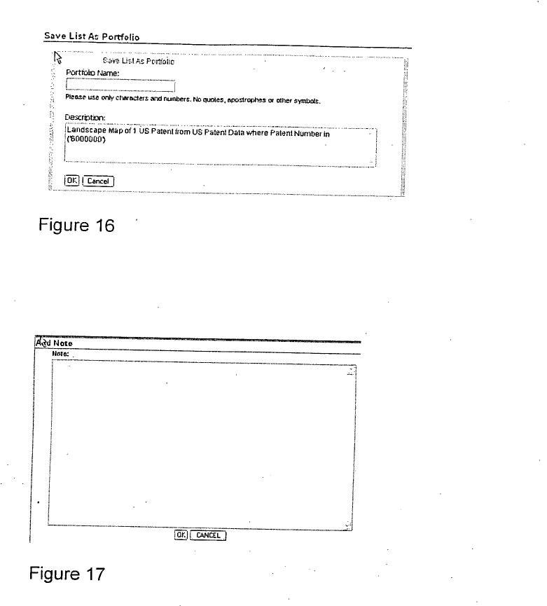

The Save List as Portfolio option creates a searchable list. This item may be displayed in the search drop down list to allow access to the data. A Save List as Portfolio window is shown, for example, in FIG. 16.

Add Note

A user may add comments about a patent list in the freeform text box, as shown, for example, in FIG. 17. This note may be displayed if accessing the File Info tab in this embodiment.

Export File

A list may be exported in CSV or Excel formats so that it may interface with other documents generated by the user in this embodiment.

Create Sublist from Selected or Unselected

A group of patents may be selected either by selecting patents in list view or by selection in map view. The selected or the unselected patents may also form a sublist for further analysis. FIG. 11 shows a sublist of selected patents, for example.

Show US References from Selected

From the selected patents, other patents that cite or are cited by the selected patents may be displayed in a sublist format in this embodiment.

Forward and Backward Citations List

A Forward and Backward Citations operation may create a list of forward and backward citations of patents in a list. This list may be mapped and analyzed using list view, for example.

Forward and Backward Cousins List

From a Starting List of one or more patents a list of cousin patents may be created. Backward Cousin patents in this context refers to patents which cite the same patents as the Starting List. Forward Cousin patents in this context refers to patents which are cited by the same patents which cite the Starting List. A Forward and Backward Cousins operation may create a list of forward and backward citations based at least in part on a forward and backward citations list. These patents are two-levels of reference citations away from the original list of patents, in this example. A new list may then be mapped and analyzed using list view operations, for example.

Citation Analysis

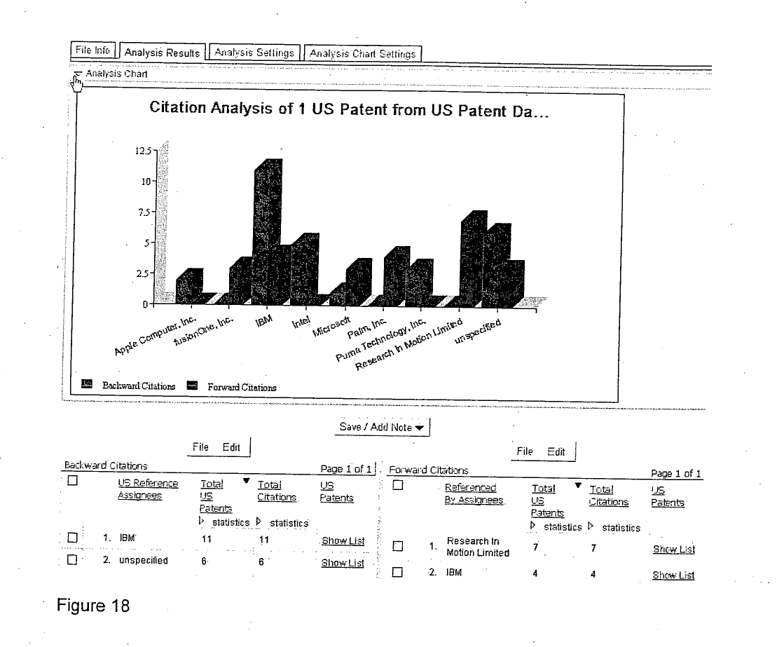

A Citation Analysis operation may provide statistical data about patents in a list. These data may also be presented in various charts and graph formats for qualitative and quantitative analysis. The main citation analysis window, for example, is shown in FIG. 18.

As shown in FIG. 18, a bar chart representation of assignee for forward and backward citations is displayed in the chart display window. Below the chart are the lists of forward and backward citations. The Save/Add Note button allows a user to save the chart to disk or add a note. The File and Edit buttons allow the user to export the list in CSV or Excel formats and to create sublist from selected, create sublist from unselected, and/or show US references from selected.

The title row in the backward and forward citation lists include: a box that allows a user to select patents in the list, US Reference Assignees, Total US Patents, Total Citations, and/or US Patents. The Total US Patents column lists the number of citations that are US patents. The Total Citations column lists the total number of citations. The Statistics buttons provide minimum, maximum, median, and/or mean number of patents in the list. The US Patents link generates a sublist containing all citation patents from the same primary assignee. These columns may be sorted in ascending or descending order.

Citation Analysis Toolbar

At the top of a chart in Citation Analysis is a set of toolbars, which include: File Info, Analysis Results, Analysis Settings, and/or Analysis Chart Settings.

File Info

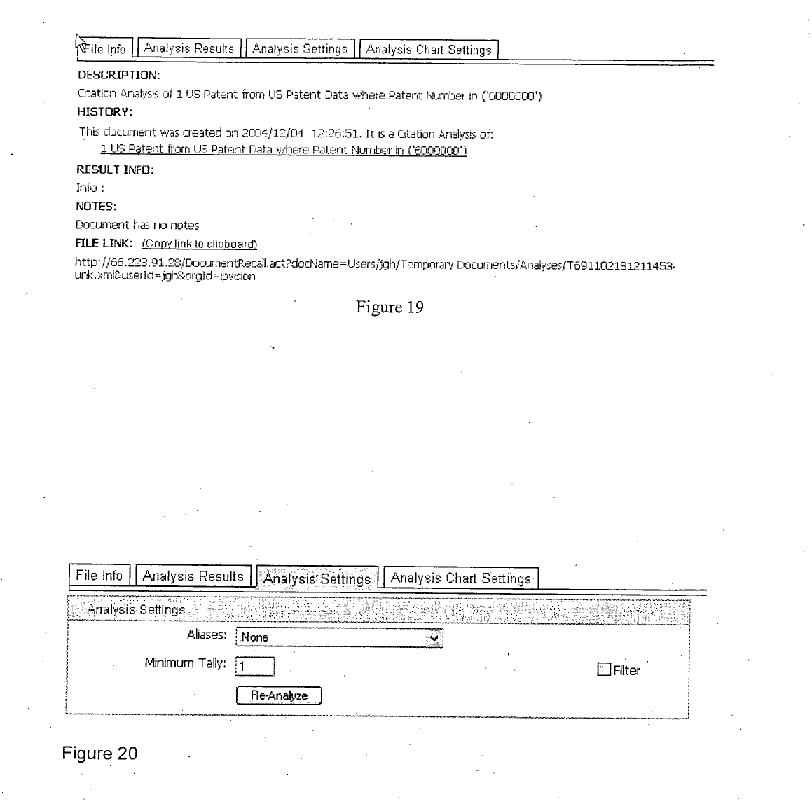

File Info in this embodiment may provide a description of a chart as shown, for example, in FIG. 19. This Description may be modified in Analysis Chart Settings.

A History section documents the date and time the chart was created as well as the data source for the chart. If the list is generated through multiple tiers of sublisting, this information may be summarized under the History tab. The list of histories may be expanded or hidden from view. Items in the history section may be linked to either a List View or Map View of the original data.

The Notes section may contain user generated notes.

The File Link section may contain a URL link to the chart. This link may be copied and pasted into other word-processing and spreadsheet documents for hyperlink access of the chart. If accessing this chart from other documents, the user may be prompted to enter a user ID and password.

Analysis Settings

Often, names of an assignee may be spelled differently in different patents. A user may identify these patents and consolidate them by the Aliases function, as shown, for example, in FIG. 20. Here, a user may type indifferent assignee spellings and provide a common alias for them. The common alias may replace the original assignee names in the forward and backward citation lists. Additionally, since companies undergo mergers and acquisitions, it may be useful to group together patents from different assignees. A common alias may also be created for a group of patents from different assignees based on a user specification in this embodiment. A user may select the Filter option in FIG. 20, for example, to isolate those patents that have been grouped together under a common alias.

Analysis Chart Settings

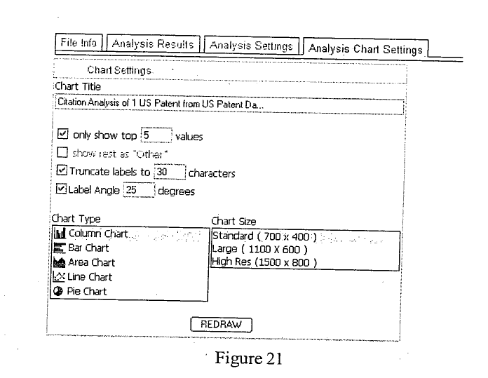

Analysis Chart Settings may allow a user to modify chart display parameters including: chart title, label settings, type of chart, and/or chart size, for example. Standard column, bar, area, line, and pie charts are available in this embodiment. This is shown, for example, in FIG. 21.

Interconnection and Landscape Maps

A user may choose to create Interconnection or Landscape Maps for patents in a list.

Forward and Backward Landscape Maps

Forward and backward landscape map in level 1 may display either the forward citations, as in FIG. 22B, for example, or the backward citations, as in FIG. 22A, for example, respectively.

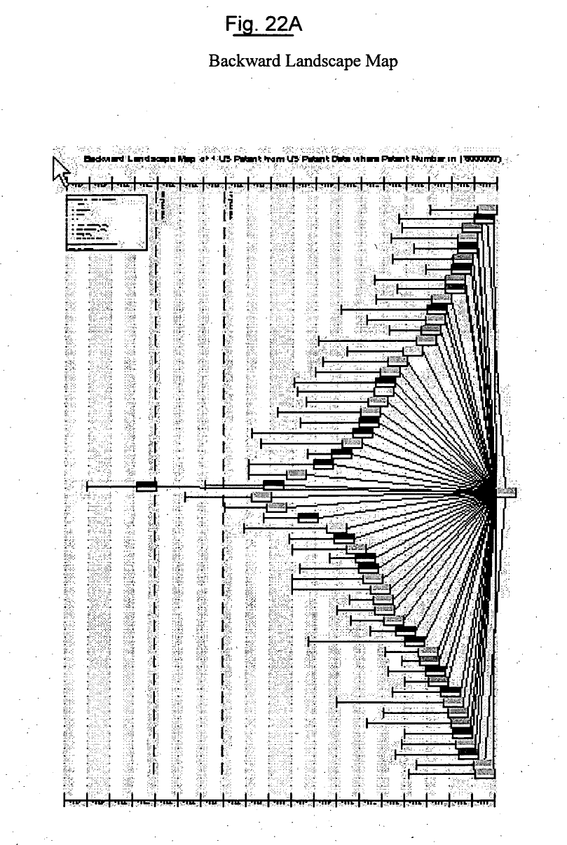

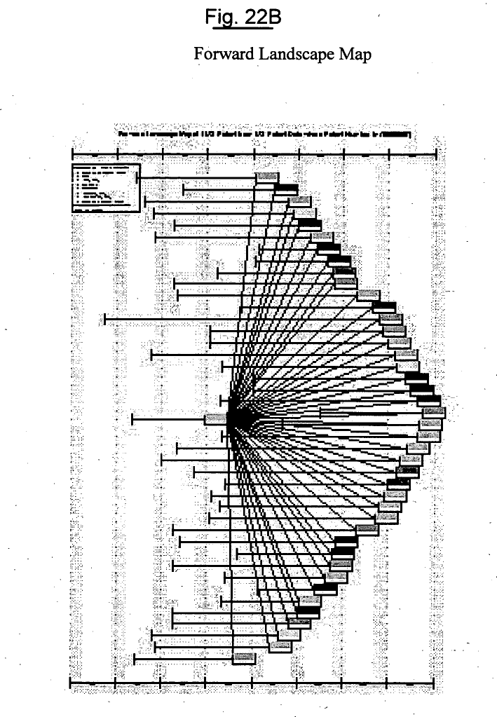

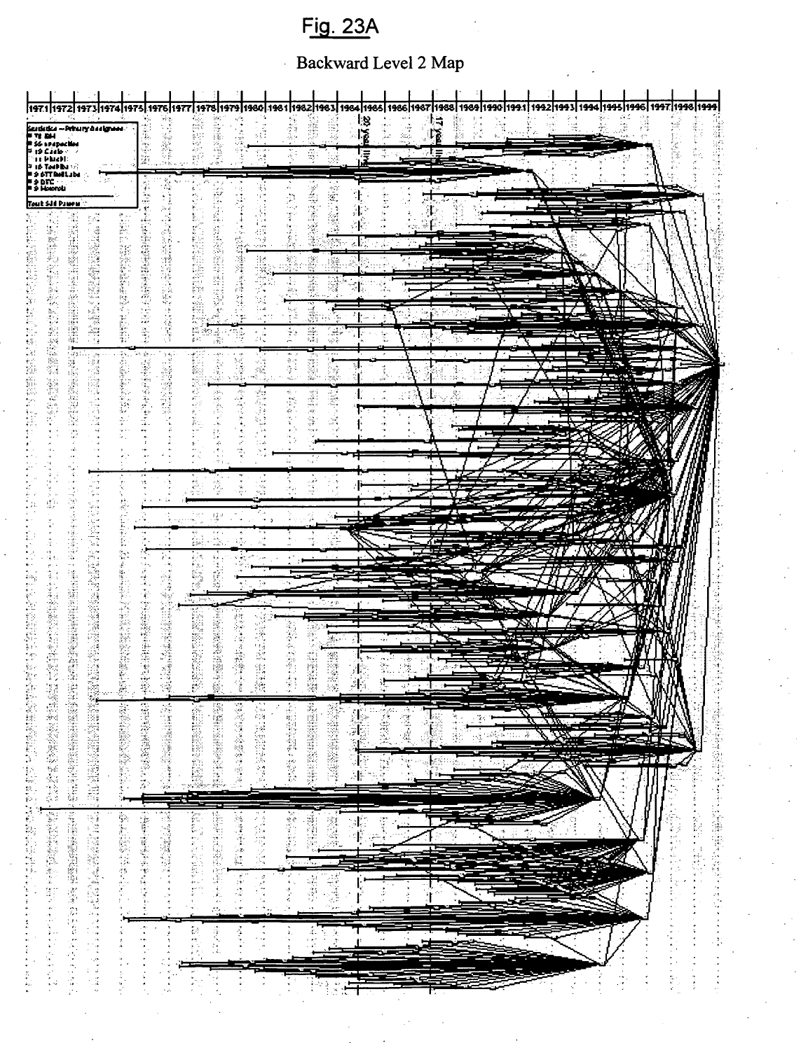

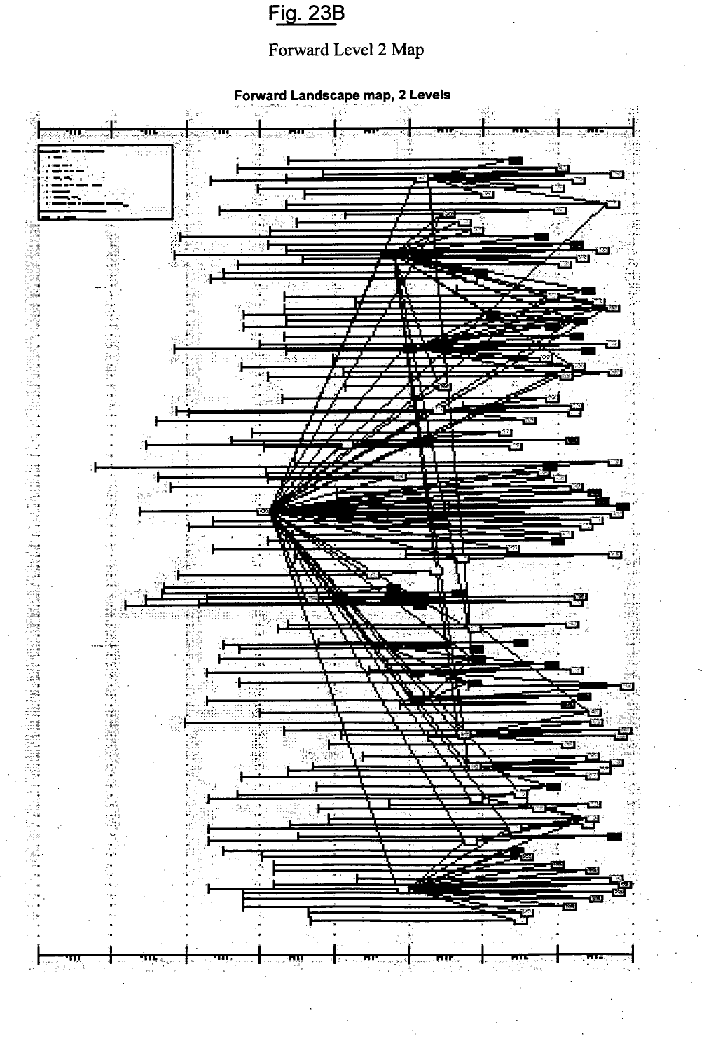

Forward and backward landscape map in level 2 may generate a list of the forward or backward citations of the original forward or backward citations. The combined citation list is displayed. The level 2 maps of the maps in FIG. 22 are shown in FIG. 23.

Prior Art

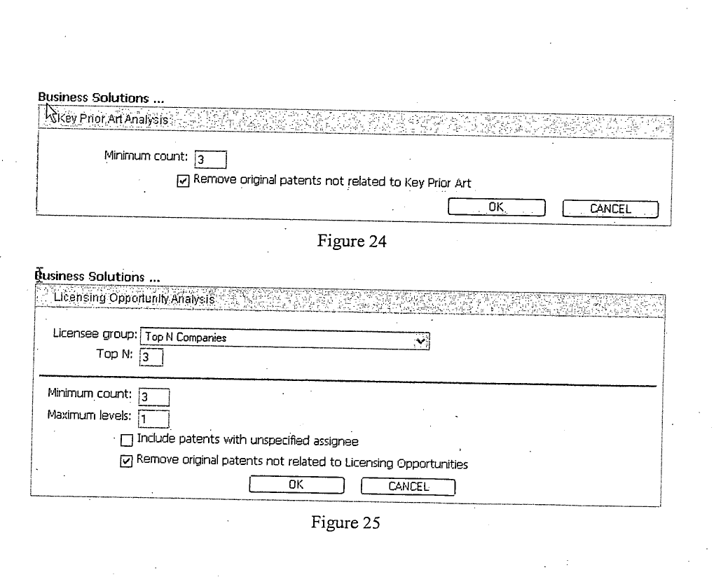

Based at least in part on backward citations, a user may identify “prior art” that has been cited by more than a particular number of reference patents in the list. The particular number may be specified in a Prior Art Analysis window, as shown in FIG. 24, for example. A landscape map is displayed, for example, that shows citation links from the reference patents to the prior art cited by the reference patents. There is also an option to remove original patents not related to prior art for visualization purposes, for example.

Licensing Opportunity

Based at least in part on forward citations, a user may identify clusters of patents associated with an assignee that also cite a reference patent. Since the identified assignee holds several patents that cite the reference patent, it may be a good candidate to which to license the reference patent. In a Licensing Opportunity Analysis window, a user may specify a type of licensee group (Top N companies, hardware companies, software companies, pharmaceutical companies, and/or other specified companies), the value of N, minimum number of patents that cite the reference patent, and/or maximum levels of citations. A landscape map may then be generated. Options may include patents with unspecified assignee and/or removal of original patents not related to licensing opportunities.

Forward and Backward Cross Dependencies

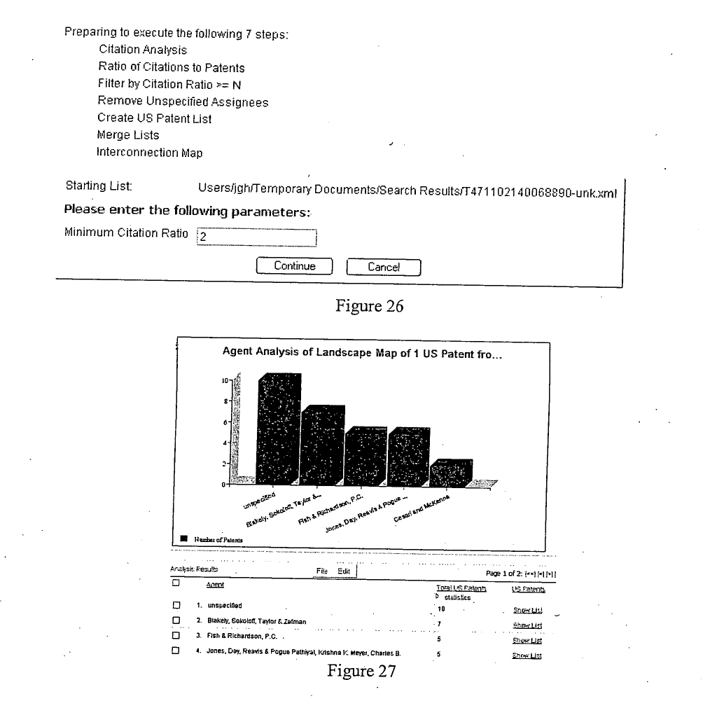

Based at least in part on a list of forward and/or backward citations, it may be useful to identify citations for assignees that reference a common patent. This may accomplished by a sequence, as shown, for example, in FIG. 26. The result may include an Interconnection Map of the patents that match a citation ratio criteria, for example.

Analytics

It may be useful to generate additional statistics on particular patents. Analysis may be based at least in part on agent, assignee, examiner, inventor, filing date, issue date, US class, and/or US class pair, for example. This information may be summarized in chart and/or list format as shown, for example, in FIG. 27. The File and edit buttons allow further actions to be taken.

Find Similar Patents

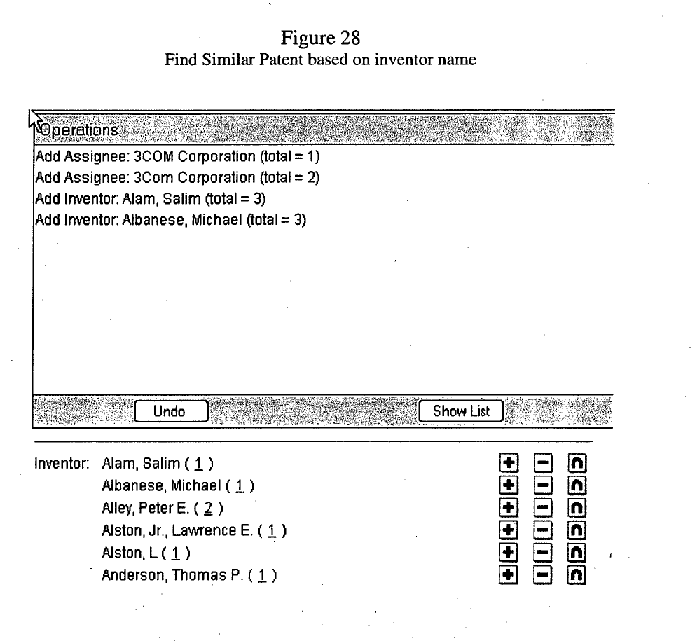

Find Similar Patents is an operation for patent identification and grouping. A user may find similar patents within the current list or within another portfolio. The following criteria may be used to assess the similarity of the patents: inventors, assignees, examiner, primary and/or secondary US classes, application date, and/or issue date. FIG. 28 shows a command window for finding similar patents based at least in part on inventor name, for example. The operations window lists similarity criteria used to identify similar patents. These criteria may be added or removed individually using operators as previously discussed, for example.

Special Shape Drop Maps

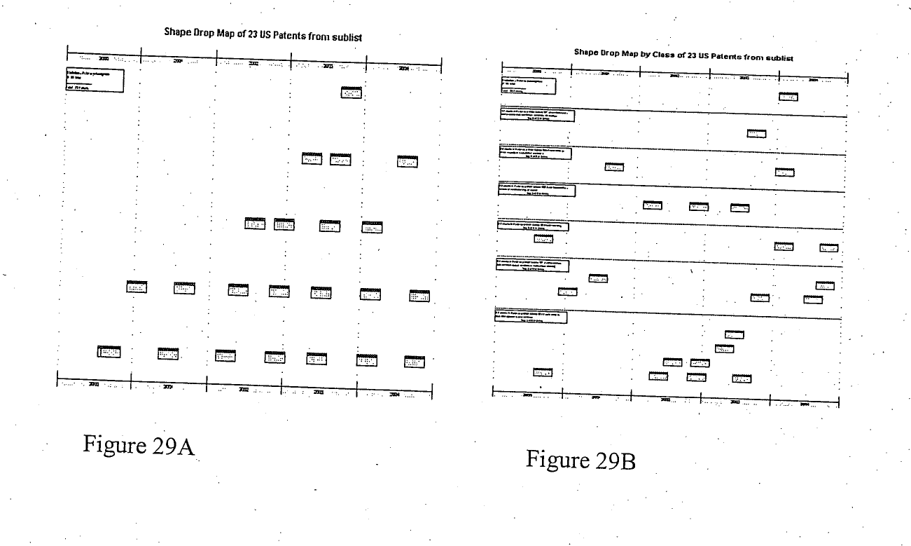

A map view may arrange patents in time context, without citation links as shown. This map may allow a user to assess the number of patents issued in a year, thereby obtaining patent portfolio growth information, either for a user's own portfolio or for competitors' portfolios for example. FIG. 29A, for example, shows a Shape Drop Map. FIG. 29B shows a Shape Drop Map where rows correspond to patent in the same US Class, for example.

Additional Features

Aside from the visualization and/or analysis operations in Map View and List View, additional operations may be provided. Operations may include, for example: File Info, List View, Citations, Patent Map, and/or Patent Map Settings.

File Info

File Info contains similar features as the File Info operation in Citation Analysis. An example is shown in FIG. 19.

Citations

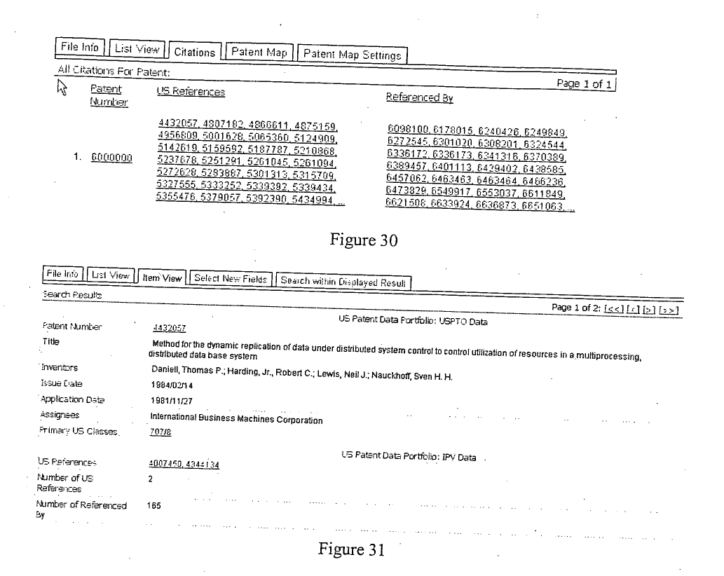

Citations operations list the citations of the reference patents as shown in FIG. 30, for example. This tool is available for a Landscape Map, for example.

Sublist View

Sublists may be generated from Map View or List View as discussed previously. Functions may include: File Info, List View, Item View, Select New Fields, and/or Search within displayed result.

Item View—Lists patents one at a time as shown, for example, in FIG. 31.

Select New Fields

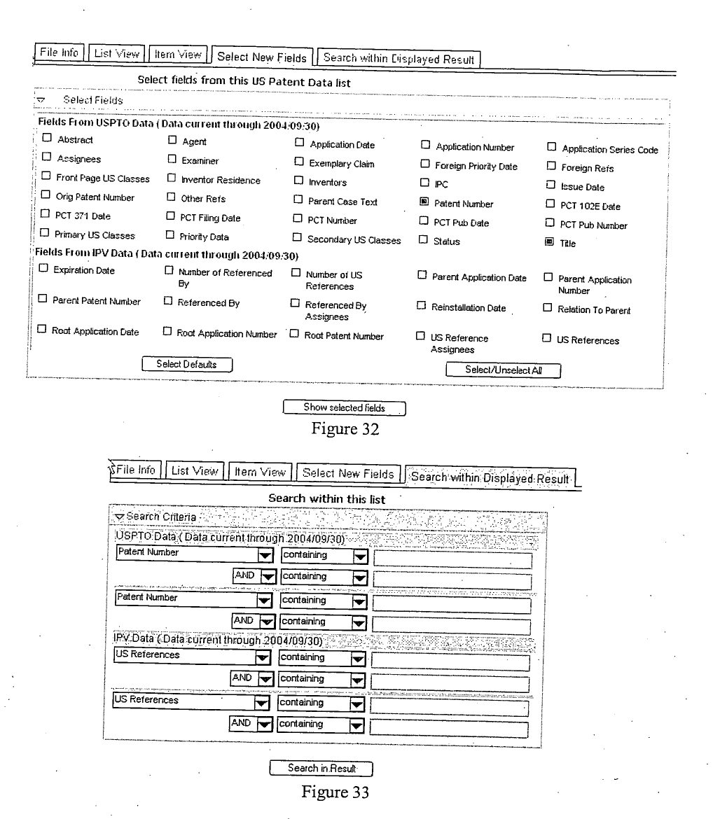

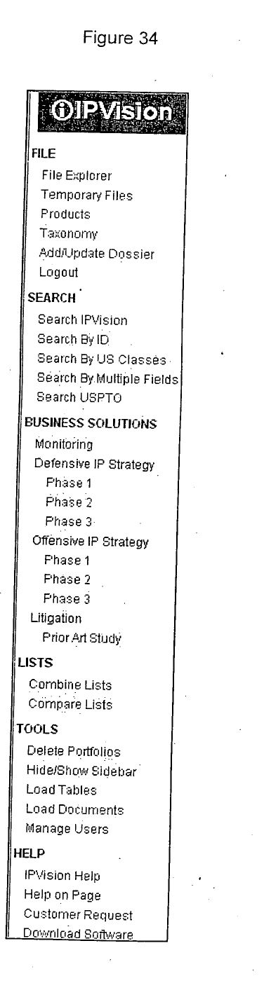

A default sub-list view displays the Patent Number and Title of a patent. A user may select a multiple of other parameters to be displayed in sub-list view, including for example, public or private information, proprietary data and data derived by calculation or analysis of or on public, private or proprietary data. Possible parameters are shown in FIG. 32 for example.

Search within Displayed Result

A sub-list may be further refined by refinement searches using a window shown in FIG. 33, for example.

File

File Explorer

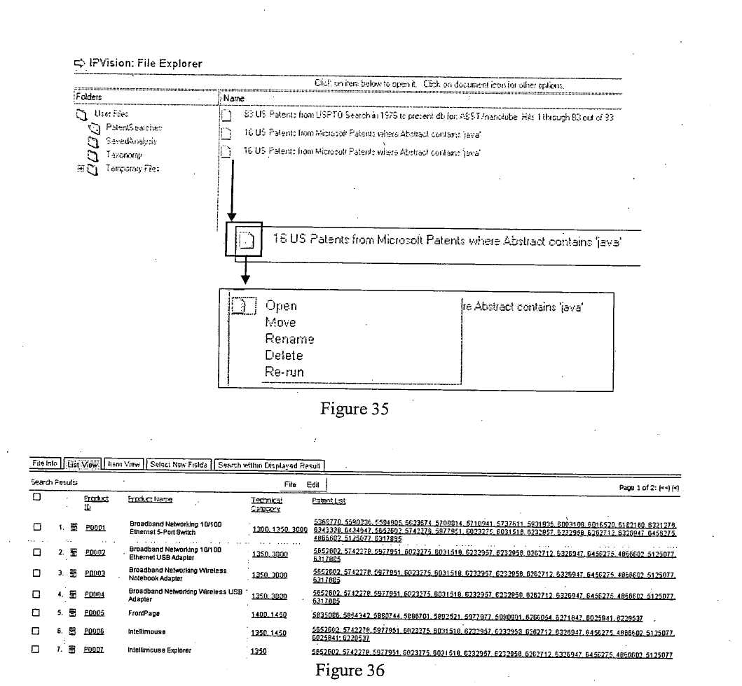

A File Explorer menu item from a Task Menu Sidebar presents users with a folder structure from which previously completed searches and/or analyses may be selected. A File Explorer Window is shown in FIG. 35.

There are two right-click action menus in the File Explorer. Right-click on the folders brings a user to a Folder Action Menu. The options are: Set Sharing, Open Folder, Open All Folders, and/or Close All Folders. In particular, the Set Sharing option allows a user to set permissions for file sharing with other users. Right-click on the File Icon brings a user to a File Action Menu. The options are: Open, Move, Rename, Mark/Unmark, Delete, and/or Rerun. In particular, the Re-run feature re-runs operations which were taken as the file was created—e.g., a Search followed by an Inventor Analysis.

Products

A mapping of Products to Technical Categories to Patents may be useful in a variety of contexts. A Products menu item provides users with a view on intellectual property from a Products perspective. FIG. 36 shows a sample screen for a Microsoft demonstration database, for example. This feature allows an organization to track its patent portfolio or competitors' patent portfolio by product offerings.

Taxonomy

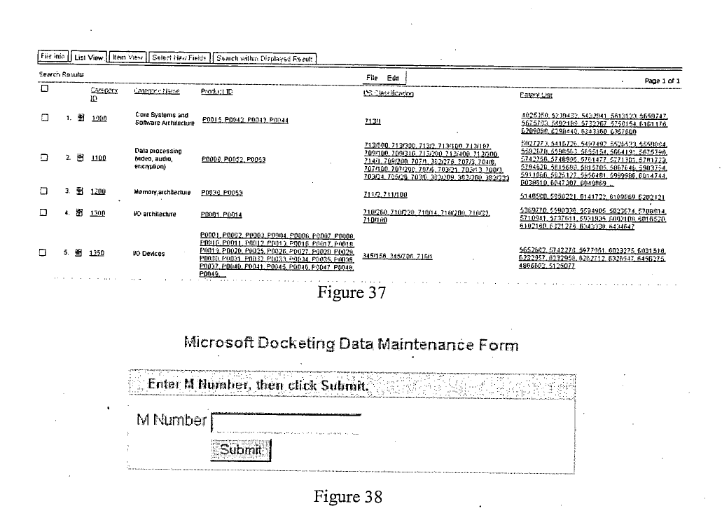

A Taxonomy menu item provides users with a view on intellectual property from a technology perspective. FIG. 37 shows a sample screen for a Microsoft demonstration database. This feature allows an organization to track its patent portfolio or competitors' patent portfolio by technology categories.

Add/Update Dossier

Add/Update Dossier provides a user with access to an IP Management Dossier feature. This particular embodiment allows connecting external data (e.g. USPTO Patent Data) with internal organization data (e.g. Product information, Publications, and/or Docketing System Information, for example). With the Dossier feature, an IP Manager may view information from a Docketing System, the USPTO, and/or internal working notes all in one place.

A particular record in a Dossier function may be accessed by typing in a Dossier number (e.g. M1000) in a Docketing Data Maintenance Form, as shown in FIG. 38, for example.

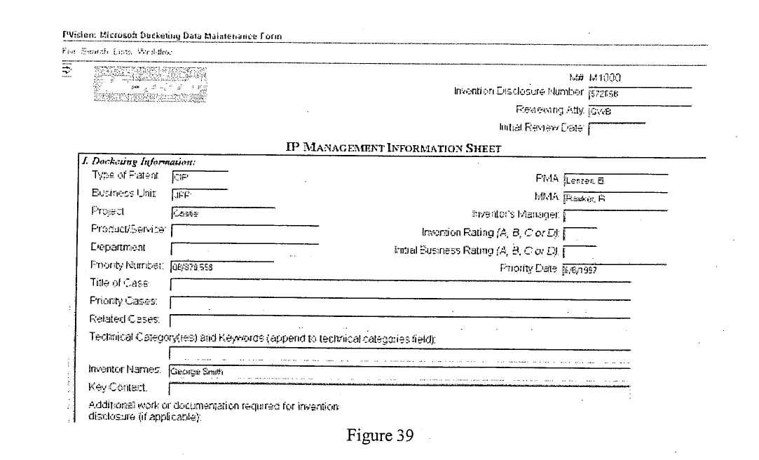

FIG. 39 shows an example Dossier record from a Microsoft Demonstration Database. Internal data such as Invention Disclosure information, Business Unit and/or Project information may linked to a related Patent, for example.

Dossier information may be accessed by number (e.g. M1000 in the above example) or by keyword searches (e.g. show me all invention disclosures, patent applications and/or patents which relate to my JPP Business Unit or the Castle Project).

Search

A range of patent search capabilities may be provided through linking with websites, for example. These include patent searches and/or claim searches in various patent databases (e.g., USPTO, EPO, JPO, IPV).

Search Parameters

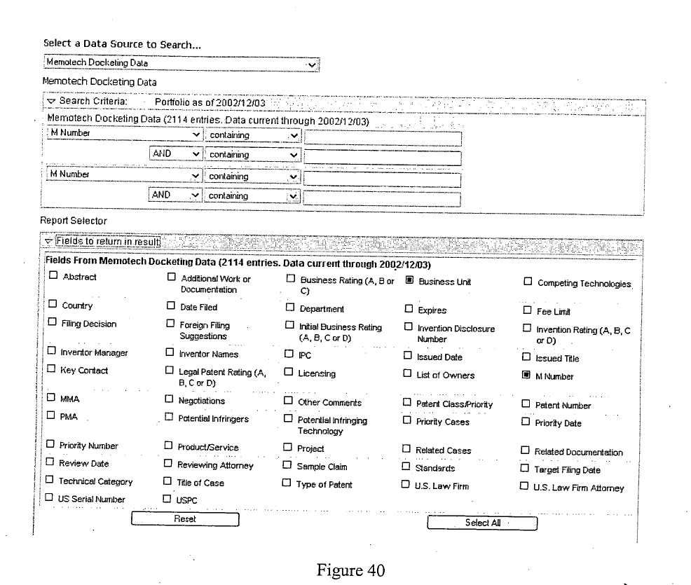

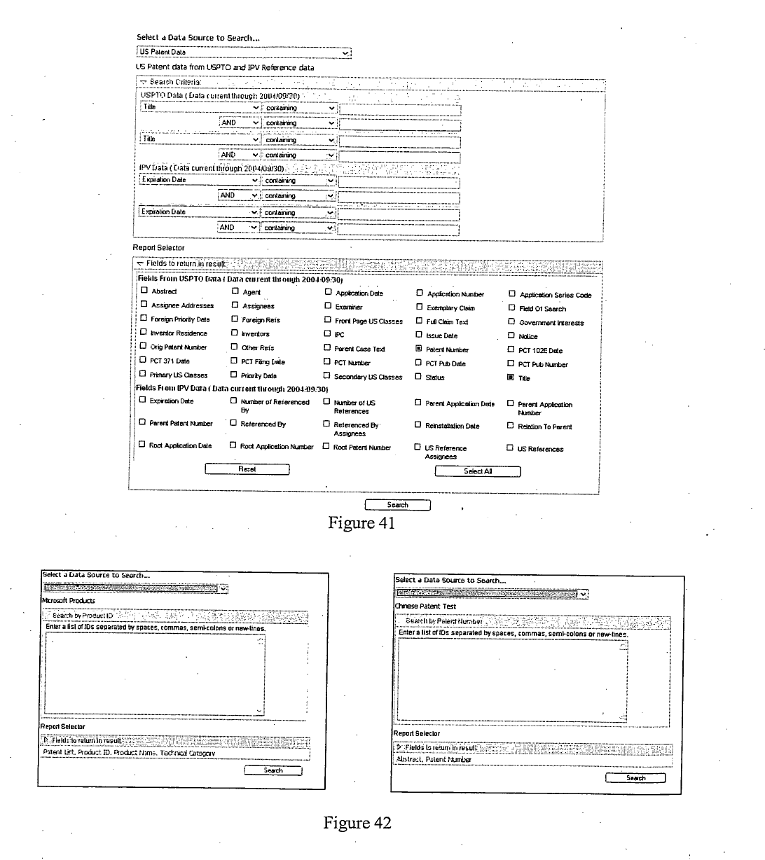

Search capabilities on patents, claims, dockets, and/or custom portfolios may be provided. Some examples of search windows are shown in FIGS. 40-41.

Search By ID

Search by ID allows a user to enter in a list of IDs for patent or other searches. Two examples of Search by ID windows are shown in FIG. 42: a search of Chinese patents and a search of Microsoft products.

Search By US Classes

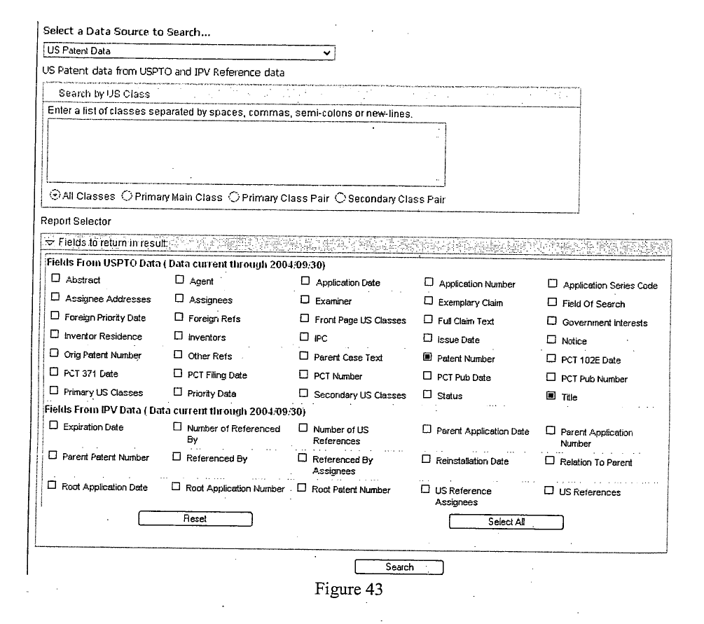

Patents may also be searched based at least in part on USPTO classes. A user may enter a list of class numbers in a search form, as shown, for example, in FIG. 43. Search options include search in all classes, primary main class, primary class pair, and/or secondary class pair, for example.

Search BY Multiple Fields

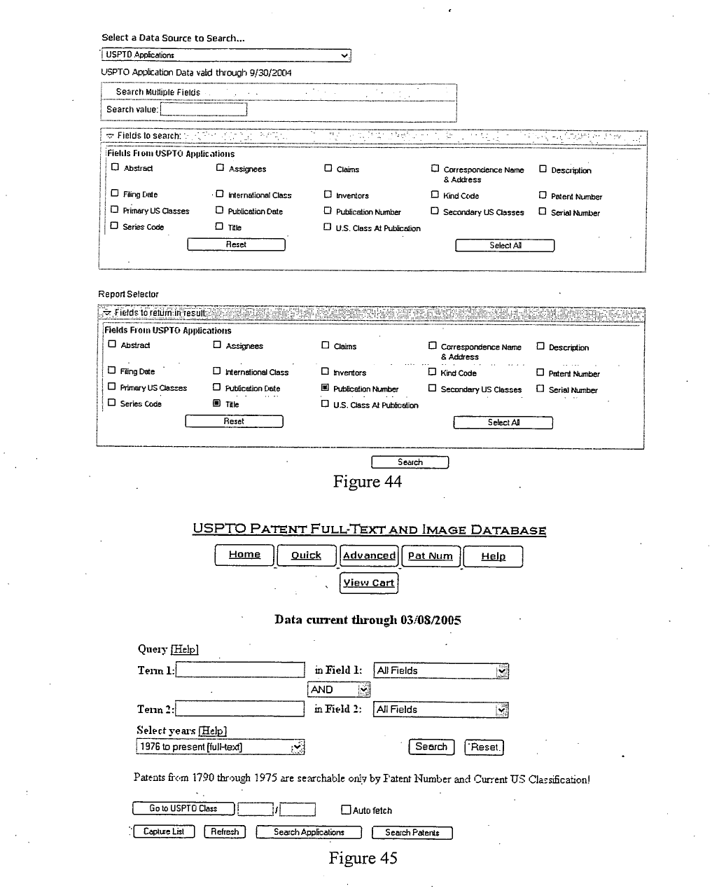

A Search by Multiple Fields function allows a user to search over multiple fields in multiple portions of a Data Source. Searchable fields may depend at least in part on the Data Source chosen. One example search window is shown in FIG. 44.

Search USPTO

Seamless integration with the USPTO search operation may be provided. As shown in FIG. 45, the top portion of a search window is identical to the USPTO search form. The bottom portion provided additional operations, including Go to USPTO Class, Capture List, Refresh, Search Applications, and/or Search Patents.

Business Solutions

A set of Business Solutions features allows a user to keep track of patent activities in key companies and fields. Defensive, Offensive, and Litigation studies may also be provided.

Monitoring

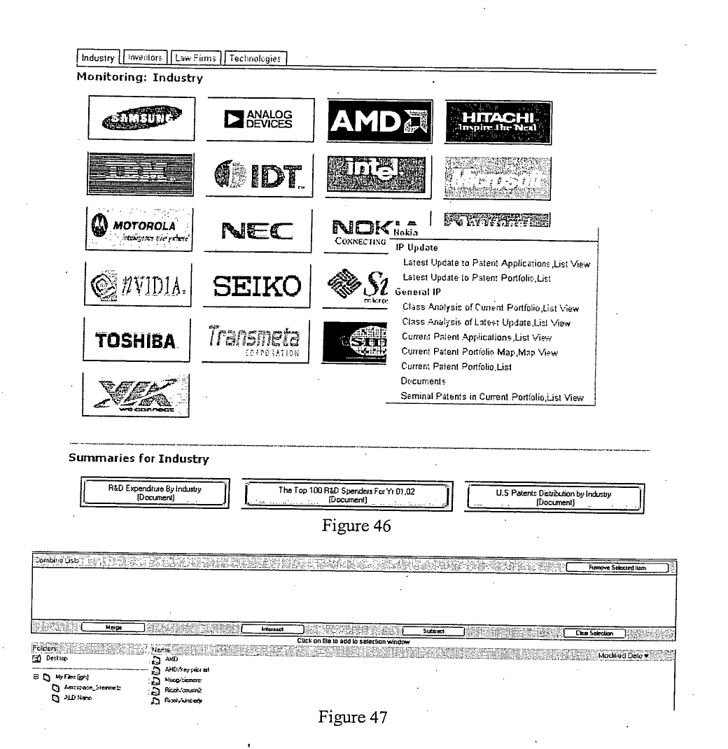

This feature allows a user to monitor a group of pre-selected patents by industry, inventors, law firms, and/or technologies, for example. A Monitoring Window is shown in FIG. 46. Clicking on an industry name generates a list of information about the particular object, including patent portfolios and/or documents.

Lists

Combine Lists

A user may select multiple pre-generated lists from the File Explorer Window and either merge the lists, take the intersection of the lists, and/or remove the contents of one list from another. The Combine Lists window is shown in FIG. 47, for example.

Compare Lists

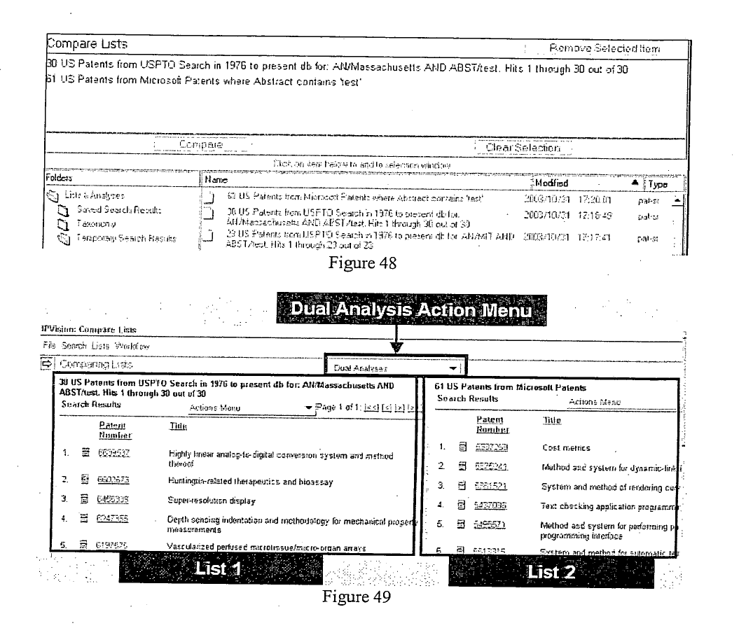

A Compare Lists window in FIG. 48 allows a user to select two lists for comparison.

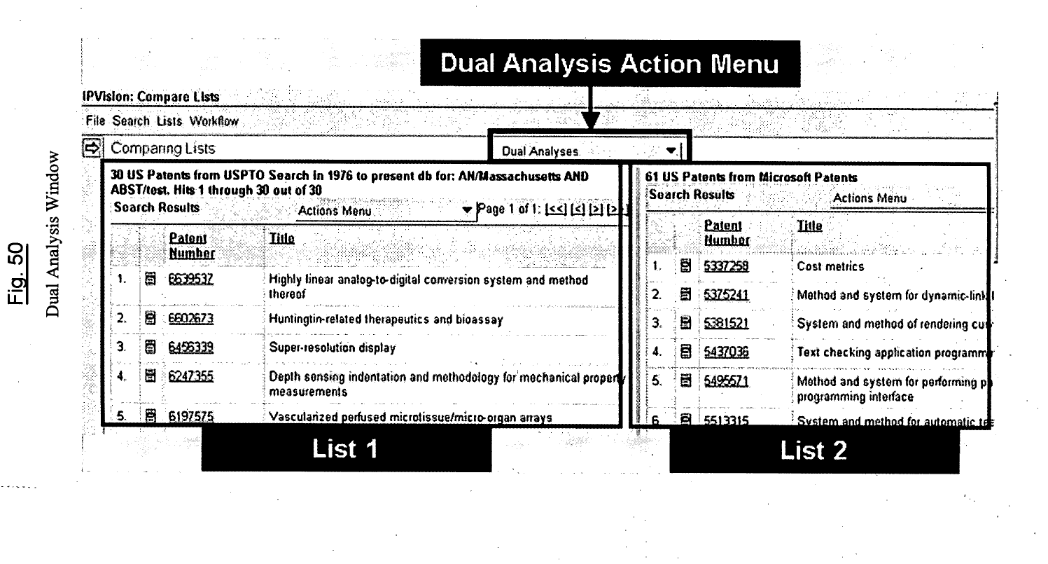

Selected patent lists are displayed side-by-side in a Dual Analysis Window, as shown in FIG. 49, for example.

In FIG. 50, Patent Application Filing Dates of List 1 (Massachusetts Institute of Technology patents containing “test” in the abstract) are compared with List 2 (Microsoft patents containing “test” in the abstract). Note that the Filing Date of Microsoft's patents are more recent than those of MIT.

Additional operations include Delete Portfolios and Hide/Show. A user may also load tables and/or documents associated with a file into the database for analysis.

Additional Functionality

A sophisticated system embodiment for the visualization and/or analysis of a large collection of data has been described. The particular embodiment described provides issued patents and/or patent applications with a variety of visualization, organizational, analysis, and/or presentation operations, as previously discussed. Of course, claimed subject matter is not limited in scope to this particular embodiment, as made clear throughout the prior discussion. Furthermore, additional functionality, such as pre-processing, searching other databases, etc., may also be included, as described below

Patent Databases

This particular embodiment also includes search capabilities for the United States Patent and Trademark Office (USPTO), European Patent Office (EPO), and Japan Patent Office (JPO) via their websites in this particular embodiment.

Analysis Update and Preprocessing

A patent database may be updated regularly to include new patents and patent applications. Likewise, update alert services that may take the form of e-mails, short messages, telephones, and/or faxes may be included. An automatic “re-analysis” service that incorporates new patents and applications for prior analysis results in a user's portfolio may be provided. Users may be notified if the results have changed or changed substantially based at least in part on some alerting criteria. Users may also choose to save the “re-analysis” results under a different file or portfolio name. This may be useful for a time sequence analysis of patent portfolios' development and progression over time.

Assignee Information

Since assignees for a patent may change through a patent's life due to mergers and acquisitions, for example, it may be useful to gather the current assignee information for an issued patent. Thus, it may be desirable to retain a past history of the assignees for a patent.

Other Associated Databases

Often, business intelligence information may enhance the value of a patent search. Thus, an interface with other IP and business intelligence services that may be transparent to a user may be provided.

Data Preprocessing

Various operations may be preprocessed offline to save search and analysis presentation time for a user. Forward and backward citation references for patents when new patents are loaded into the database may be performed in this manner. This may reduce the amount of time for real-time citation list generations. A patent portfolio may be also be customized such that company products, technologies, and/or departments may be associated with patents in a portfolio.

Text preprocessing features may include: finding and correcting spelling errors, standardizing spelling for assignee names, inventor names, etc. Additional advanced preprocessing may include identifying key words, associating words with a set of synonyms or a set of pre-built related words by experts, associating words with appropriate dictionary definitions or computing a relevance score between a word and dictionary definitions, computing a similarity score between a patent and its citation references, associating figures with keywords, constructing a patent history tree, constructing a corporate tree, and finding other industry related data for identified patents. The product, technology, and/or department information associated with a patent may also be updated regularly to reflect organizational changes. These features may be performed offline or online with direct user input and feedback.

Searches in Multiple Databases

Having US or worldwide patent and patent application information in one system may reduce patent search effort. For example, it may be desirable to have the capability for substantially simultaneous or at least concurrent searches in multiple patent databases.

Search String

As previously described, keyword search, search by ID, search by multiple fields, search by US classes, and/or direct search in USPTO capabilities are provided in this particular embodiment. A set of operators (e.g., containing, not containing, begins with, equal to, not equal to, greater than, less than greater/equal, and/or less/equal) may used in conjunction with Boolean operators.

In addition to Boolean operators AND, OR, and NOT, it may also be useful to provide wild card operators that may account for different spellings of the same word, singular and plural nouns, and/or different tenses of the same verb. Likewise, search by associated words, synonyms, and/or text description of the item of interest may be desirable.

Search by Citation Reference

Related patents around a reference patent or a group of reference patents may be searched by citation reference, as previously described. More sophisticated search methods based at least in part on text preprocessing may also be employed. Some of these preprocessing techniques may serve to limit the scope of the search while others serve to expand the scope. Note that often, an object may be described by several synonymous words. Since the quality of a patent search relies heavily on the input search keywords and/or phrases, it may be useful to identify synonymous words for user inputs and perform searches on relevant words. On the other hand, often a word has multiple definitions but only a subset is relevant to the intended search object. It may therefore be useful to allow a user to select an appropriate meaning for a keyword from a dictionary so that relevant patents may be found. Another useful search tool may include search by figures if the figures are associated with a set of keywords or descriptions during data pre-processing.

Spelling Inconsistencies

It may be desirable to preprocess texts to correct for spelling errors and inconsistencies in inventor names, assignees, etc.

Map Visualizations

As previously discussed, Interconnection maps and Landscape maps may display citation relationships between patents. Landscape maps may map the citation references of a single patent or for a group of patents. In Interconnection Maps, more densely connected patents may be displayed towards the top of the map window for visualization. Several levels of Landscape maps may also be generated.

Displaying patents based at least in part on similarity clustering, keyword search, assignee, inventor, and/or other data association features may be desirable. Similar patents may be grouped into clusters without citation links to facilitate patent selection on the map. One possibility for a different kind of map is one that comprises a circle with patent boxes on the circle and citation links interconnecting the patent boxes. This may be helpful in visualizing the degree of connection of a patent, and may also assist in patent selection since similar patent may be arranged to be adjacent to one another on the circle. Another possibility may include a Venn diagram that shows intersections of patent in different categories (e.g., intersection of patents that have the same assignee, inventor, issue year, etc).

Map Contents

A map may displays patent visually in a time context. A patent box may contain detailed information about the patent. Patent filing date and issued date may also be obtained from a map. The number of backward and forward citations of a patent may be obtained from each patent box. Patents with the same assignee may be displayed with color coding. A legend on a map view may provide various statistics with respect to the patents on the map. The specific type of statistical data may be specified by the user.

Map Features

Maps here may be zoomed in and out to display detail and/or global views. A small view window allows a user to select a particular portion of the map for detailed view. Using the mouse cursor, a user may move a rectangular selector around the view window to expose different areas of the map view. A hover/enlarge capability magnifies the contents of a patent box as the cursor moves over the patent box so that the contents of the box may be read. Right clicking on a patent box provides access to a variety of data for further actions relating to the patent. Patents may be selected by common category, such as assignee, inventor, patent class, etc, and selected from a list or selected by patent ID. Selected patents may be highlighted on a map. A user may select or deselect patents from the patent map for further analysis and visualization. The selection methods may include click-select/deselect and group selection by lassoing or dragging with a mouse pointer. Various color coding options may be provided.

Alternately, different shapes for patent boxes (rectangle, triangle, circle, etc), different sizes or orientation of patent boxes possibly to indicate other attributes (strength of claims, products related to the patent, associated revenue or profit, etc.), different colors for forward and backward citation links (possibly to indicate degree of connectivity), and/or different shadings for similar patents may be employed. Selected patents may be indicated by different patterns of shading (e.g. stripe), colors that flash at regular intervals, and/or a large circle around the patent boxes. Additional drawing tools may be supplied so that a user may enhance any portion of a map manually.

Additional features may include the capability of selecting and/or deleting a group of patents on a map (with or without map regeneration), patent searches on a map (with appropriate patent identifications, for example), and the ability to drag a patent box or a group of patent boxes to a desired location on a map. More advanced zoom features may allow a user to zoom into a desired portion of a map by a click of a zoom button.

Since an issued patent may have prior patent applications (with prior date claim) or may be closely affiliated with a group of prior patents, it is useful to indicate this association on a map. One way of indicating this association may be by changing prior patent boxes to a dot along a line as the most current patent. In some cases, a company may also have patents currently in development. It may be useful to include these patents on a patent map as well.

Map and List Interface

Landscape map and lists may be generated from a subset of selected patents in map view. Patents shown in a map view may be presented in a list that may be sorted according fields in various columns. Selected patents in a list view may also be selected on a map view and vice versa. Selected patents may be used to recursively generate additional maps and lists.

Analysis

Citation analysis may provide statistical information about selected patents. Quantitative results may be displayed in a chart format. Different patent lists may be combined for further analysis or compared. The comparison results may also be displayed in charts. From the patent citations, one may obtain prior art and/or licensing opportunity information. Patent claim analysis may also be applied in assessing the strength of a company's patent portfolio.

Business Solutions

Users may monitor patent status of major competitors or industry leaders. Technology areas covered by these companies may be identified. A docketing system for tracking of public and private data may be linked. These may be seamlessly integrated with previously described visualization and/or analysis operations. The patents of companies may be associated with a company's product and/or technology information, allowing patent portfolio management.

Results Presentation

Lists, figures, and/or charts may be generated. These documents may be saved in a variety of file formats or exported for off-line processing. It may be useful to automatically generate a comprehensive report after a patent or claims search. Users may select specific lists, figures and/or charts to be included in the report.

Ease of Use

This particular embodiment is implemented in a standard browser without any plug-ins or downloads. Users are given a graphical application like feature experience, such as with patent maps, for example. A “re-run” function allows a user to carry through a previously performed set of analysis over again automatically. Frequently accessed folders may be included into the pull-down menu lists for access.

Application Extensions

Visualization and/or analysis may be applied to a variety of databases. Some possibilities may include:

Tracking academic publications and citations.

Tracking personnel records in project based companies. Visualization tool may be useful for assisting with project team formation and hiring decisions, for example.

Visualizing and/or tracking evolutionary relationships between living organisms, genes, or proteins.

It will, of course, be understood that, although particular embodiments have just been described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example.

In the preceding description, various aspects of claimed subject matter have been described. For purposes of explanation, specific numbers, systems and configurations were set forth to provide a thorough understanding of the claimed subject matter. However, it should be apparent to one skilled in the art having the benefit of this disclosure that claimed subject matter may be practiced without the specific details. In other instances, well-known features were omitted or simplified so as not to obscure claimed subject matter. While certain features have been illustrated and described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A system comprising: a computing platform; said computing platform adapted to create graphical application-like visualizations of data using a browser.

2. The system of claim 1, wherein said computing platform is further adapted to create said visualizations without a plug-in.

3. The system of claim 1, wherein said computing platform is further adapted to create said visualizations in real-time.

4. The system of claim 3, wherein computing platform is further adapted to provide an interactive viewer window to view said visualizations.

5. The system of claim 4, wherein said computing platform is further adapted to create said visualizations using user selected features.

6. The system of claim 5, wherein said computing platform is further adapted so that selectable features include at least one of the following: color; shape; and/or shading of particular graphical objects.

7. The system of claim 4, wherein said computing platform is further adapted to create an interactive hoover and/or flyover window.

8. The system of claim 3, wherein said computing platform is further adapted to recursively create visualizations.

9. The system of claim 8, wherein said computing platform is further adapted to create a visualization of a sub-portion of a prior visualization.

10. The system of claim 3, wherein said computing platform is further adapted to perform at least one of: editing a visualization; saving a visualization; exporting a visualization; and/or changing settings for a visualization.

11. The system of claim 3, wherein said computing platform is further adapted to create visualizations in real-time by searching said data.

12. The system of claim 11, wherein said computing platform is further adapted to search said data by data type and/or field.

13. The system of claim 3, wherein said computing platform is further adapted to create said visualizations in real-time by linking to a database and downloading data from said database.

14. The system of claim 13, wherein said database comprises a product database.

15. The system of claim 13, wherein said computing platform if further adapted to access said database via a local area network (LAN).

16. The system of claim 13, wherein said computing platform is further adapted to access said database via the internet.

17. The system of claim 3, wherein said computing platform is further adapted to create said visualizations in real-time by linking to one or more other websites and downloading data from said one or more other websites.

18. The system of claim 3, wherein said computing platform is further adapted to create said visualizations in real-time by at least one of: linking to a patent web site and downloading data; and/or linking to a patent docketing system and downloading data.

19. The system of claim 18, wherein said patent website comprises the USPTO website.
